(19) United States
(12) Patent Application Publication
(10) Pub. No.: US 2026/0008275 A1
(43) Pub. Date: Jan. 8, 2026

(54) RECORDING DEVICE

(71) Applicant: SEIKO EPSON CORPORATION, Tokyo (JP)

(72) Inventors: Hirohisa KODAIRA, MATSUMOTO-SHI (JP); Yuto SUZUKI, SHIOJIRI-SHI (JP); Hiroyuki KOSUGE, MATSUMOTO-SHI (JP); Yutaro HARADA, SHIOJIRI-SHI (JP); Toshikazu KOTAKA, MATSUMOTO-SHI (JP); Masaaki NISHIZAWA, NAGANO-SHI (JP); Kenichi SHIMO, SHIOJIRI-SHI (JP)

(21) Appl. No.: 19/256,753

(22) Filed: Jul. 1, 2025

(30) Foreign Application Priority Data
Jul. 3, 2024 (JP) 2024-107502
Feb. 17, 2025 (JP) 2025-023034

(51) Int. Cl. B41J 11/00; B41J 3/60; B41J 13/03; B41J 29/13

(52) U.S. Cl. CPC B41J 11/006; B41J 3/60; B41J 13/03; B41J 29/13

(57) ABSTRACT

A recording device, wherein a part of a transport path is constituted by a first transport path, a pull-out unit capable of pulling out at least a part of the transport path relative to the housing, has a first path forming section configured to open and close, the first path forming section in a first closed state, forms an upper surface of at least a part of the first transport path and in a first open state, opens at least the part of the first transport path, and the first path forming section further has a base end path forming section, which is a section on a base end side during opening and closing and a free end path forming section, which is a section on a free end side during opening and closing and which is pivotably coupled to the base end path forming section.

The present application is based on, and claims priority from JP Application Serial Number 2024-107502, filed Jul. 3, 2024, and from JP Application Serial Number 2025-023034, filed Feb. 17, 2025, the disclosure of which are hereby incorporated by reference herein in its entirety.

### BACKGROUND

### 1. Technical Field

The present disclosure relates to a recording device for recording on a medium.

### 2. Related Art

In a recording device represented by a printer, as shown in JP-A-2016-185681, a part of a medium transport path can be opened in order to resolve a paper jam that has occurred in the device.

Specifically, the recording device described in JP-A-2016-185681 includes a pull-out unit that constitutes a part of a medium discharge path and that can be pulled out from a housing. The pull-out unit includes a pivotable path forming section and a part of the medium discharge path can be opened by pivoting the path forming section.

In the recording device described in JP-A-2016-185681, a part of the medium discharge path can be opened by opening the path forming section. However, there is room for further improvement in workability when a user works in a state where the path forming section is opened.

### SUMMARY

To solve the above problem, a recording device of the present disclosure includes a housing; a recording section that is accommodated in the housing and that is configured to perform recording on a medium; a transport path configured to transport the medium that was recorded by the recording section in a transport direction; and a pull-out unit configured to pull out at least a part of the transport path with respect to the housing, wherein a part of the transport path is constituted by a first transport path, the pull-out unit has an openable and closable first path forming section, the first path forming section in a first closed state, forms an upper surface of at least a part of the first transport path and in a first open state, opens at least the part of the first transport path, and the first path forming section further has a base end path forming section, which is a section on a base end side during opening and closing and a free end path forming section, which is a section on a free end side during opening and closing, and which is pivotably coupled to the base end path forming section.

### BRIEF DESCRIPTION OF THE DRAWINGS

FIG. 1 is a view showing an entire transport path of a medium in a printer.

FIG. 2 is a view showing a part of the transport path of the medium in the printer.

FIG. 3 is a perspective view of a switching section.

FIG. 4 is a view showing a state switching of a switching section.

FIG. 5 is a view showing a state switching of the switching section.

FIG. 6 is a view showing a state in which the switching section main body is in contact with the facing member.

FIG. 7 is a cross-sectional view showing a part of a pull-out unit and a housing and is a view showing a state in which the pull-out unit is pulled out and all path forming sections in a closed state.

FIG. 8 is a cross-sectional view showing a part of the pull-out unit and the housing and is a view showing a state in which the pull-out unit is pulled out, a first path forming section is opened, and the other path forming sections are closed.

FIG. 9 is a cross-sectional view showing a part of the pull-out unit and the housing and is a view showing a state in which the pull-out unit is pulled out, the first path forming section and a second path forming section are opened, and the other path forming sections are closed.

FIG. 10 is a cross-sectional view showing a part of the pull-out unit and the housing and is a view showing a state in which the pull-out unit is pulled out, the first path forming section, the second path forming section, and a third path forming section are opened, and a fourth path forming section is closed.

FIG. 11 is a view showing an opening and closing operation of the third path forming section and is a view showing a structure for holding the third path forming section in an opened state.

FIG. 12 is a cross-sectional view of a part of the pull-out unit and the housing and is a view showing a state in which the pull-out unit is pulled out, the first path forming section, the second path forming section, and the fourth path forming section are opened, and the third path forming section is closed.

FIG. 13 is a cross-sectional view of a part of the pull-out unit and the housing cut at a position different from FIG. 12 and is a view showing a state in which the pull-out unit is pulled out, the first path forming section, the second path forming section, and the fourth path forming section are opened, and the third path forming section is closed.

FIG. 14 is a cross-sectional view of a part of the pull-out unit and the housing and is a view showing a state in which the pull-out unit is pulled out, the first path forming section and the fourth path forming section are opened, and the second path forming section and the third path forming section are closed.

FIG. 15 is a cross-sectional view of a part of the pull-out unit and the housing and is a view showing a state in the process of accommodating the pull-out unit from a state in which the first path forming section is opened and the other path forming sections are closed.

FIG. 16 is a cross-sectional view of a part of the pull-out unit and the housing and is a view showing a state in the process of accommodating the pull-out unit from a state in which the first path forming section is opened and the other path forming sections are closed.

FIG. 17 is a cross-sectional view of a part of the pull-out unit and the housing and is a view showing a state in the process of accommodating the pull-out unit from a state in which the first path forming section is opened and the other path forming sections are closed.

FIG. 18 is a cross-sectional view of a part of the pull-out unit and the housing and is a view showing a state in the process of accommodating the pull-out unit from a state in which the first path forming section is opened and the other path forming sections are closed.

FIG. 19 is a perspective view showing a roller provided in the first path forming section and a guide surface provided in the fourth path forming section.

FIG. 20 is a cross-sectional view of a part of the pull-out unit and the housing and is a view showing a state in the process of accommodating the pull-out unit from a state in which the first path forming section is opened and the other path forming sections are closed.

FIG. 21 is a cross-sectional view of a part of the pull-out unit and the housing and is a view showing a state in the process of accommodating the pull-out unit from a state in which the first path forming section is opened and the other path forming sections are closed.

FIG. 22 is a cross-sectional view of a part of the pull-out unit and the housing and is a view showing a state in which the pull-out unit is accommodated and all the path forming sections are closed.

FIG. 23 is a cross-sectional view of a part of the pull-out unit and is a view showing the relationship between a contact plate and a pressing section provided in the first path forming section.

FIG. 24 is a cross-sectional view of a part of the pull-out unit and the housing and is a view showing a state in the process of accommodating the pull-out unit from a state in which the first path forming section and the third path forming section are opened and the other path forming sections are closed.

FIG. 25 is an enlarged view of the third path forming section in FIG. 24.

FIG. 26 is a cross-sectional view of a part of the pull-out unit and the housing and is a view showing a state in the process of accommodating the pull-out unit from a state in which the first path forming section and the third path forming section are opened and the other path forming sections are closed.

FIG. 27 is a cross-sectional view of a part of the pull-out unit and the housing and is a view showing a state in the process of accommodating the pull-out unit from a state in which the first path forming section and the fourth path forming section are opened and the other path forming sections are closed.

FIG. 28 is a cross-sectional view of a part of the fourth path forming section and is an enlarged view of a pivot section constituting the fourth path forming section.

FIG. 29 is a cross-sectional view of the first path forming section and the fourth path forming section and is a view showing the positional relationship between them.

FIG. 30 is a view showing a restriction section provided in the first path forming section and a restricted section provided in the fourth path forming section.

FIG. 31 is a plan view of a part of the third path forming section and a support section and is a view showing a state in which a supported section of the third path forming section contacts against the support section.

FIG. 32 is a perspective view of a part of the third path forming section and the support section and is a view showing a state immediately before the supported section of the third path forming section contacts against the support section.

FIG. 33 is a perspective view of a part of the third path forming section and the support section and is a view showing a state in which the supported section of the third path forming section is in contact against the support section.

### DESCRIPTION OF EMBODIMENTS

Hereinafter, the present disclosure will be generally described.

A recording device according to a first aspect includes a housing; a recording section that is accommodated in the housing and that is configured to perform recording on a medium; a transport path configured to transport the medium that was recorded by the recording section in a transport direction; and a pull-out unit configured to pull out at least a part of the transport path with respect to the housing, wherein a part of the transport path is constituted by a first transport path, the pull-out unit has an openable and closable first path forming section, the first path forming section in a first closed state, forms an upper surface of at least a part of the first transport path and in a first open state, opens at least the part of the first transport path, and the first path forming section further has a base end path forming section, which is a section on a base end side during opening and closing and a free end path forming section, which is a section on a free end side during opening and closing, and which is pivotably coupled to the base end path forming section.

According to the present aspect, since the first path forming section has the base end path forming section, which is the section on the base end side during opening and closing, and the free end path forming section, which is the section on the free end side during opening and closing and which is pivotably coupled to the base end path forming section, it is possible to improve the degree of freedom of the posture of the first path forming section and to improve the workability of the user in a state where the first path forming section is opened.

Note that in the present specification, “at least a part” means any one of a part and the whole, that is, a part or the whole.

A second aspect is an aspect according to the first aspect, wherein when the first path forming section is opened from the first closed state toward the first open state, the free end path forming section and the base end path forming section pivot relative to each other after the free end path forming section contacts against a part of the housing, whereby the base end path forming section is further opened in an opening direction.

According to the present aspect, since the first path forming section is opened from the first closed state toward the first open state, the free end path forming section and the base end path forming section pivot relative to each other after the free end path forming section contacts against a part of the housing, whereby the base end path forming section is further opened in an opening direction, it is possible to improve a larger open region can be secured when the first path forming section is opened and to improve the workability of the user in a state where the first path forming section is opened.

A third aspect is an aspect according to the second aspect, wherein the first path forming section further has a biasing member configured to bias the free end path forming section in the opening direction.

According to the present aspect, since the first path forming section further has the biasing member configured to bias the free end path forming section in the opening direction, it is possible to suppress the free end path forming section from being closed in a closing direction in the first open state of the first path forming section. For this reason, it is possible to suppress the narrowing of the open region when the first path forming section is opened.

Note that the present aspect is not limited to the second aspect above and may be dependent on the first aspect above.

A fourth aspect is an aspect according to the first aspect, wherein the housing has a first contact section configured to contact the base end path forming section, which is in an open state, in response to displacement of the pull-out unit in an accommodation direction, which is a direction in which the pull-out unit is accommodated into the housing and in a state where the first contact section is in contact with the base end path forming section in the opened state, the posture of the first path forming section is changed toward the first closed state by displacing the pull-out unit in the accommodation direction.

According to the present aspect, since the posture of the first path forming section is changed toward the first closed state by displacing the pull-out unit in the accommodation direction in a state where the first contact section is in contact with the base end path forming section in the opened state, it is possible to suppress damage to the first path forming section when the pull-out unit is accommodated in a state where the first path forming section is opened.

Note that the present aspect is not limited to the first aspect above and may be dependent on the second or third aspect above.

A fifth aspect is an aspect according to the fourth aspect, wherein the first path forming section has a pressing section and in the first closed state of the first path forming section, the first path forming section is pressed toward the first closed state by contacting the first contact section and the pressing section.

According to the present aspect, since the first path forming section has the pressing section, and in the first closed state of the first path forming section, the first path forming section is pressed toward the first closed state by the contact between the first contact section and the pressing section, it is possible to appropriately maintain the first closed state of the first path forming section.

A sixth aspect is an aspect according to the first aspect, wherein a part of the transport path is constituted by a second transport path, the pull-out unit has an openable and closable second path forming section, and the second path forming section in a second closed state, forms a lower surface of at least a part of the first transport path and forms an upper surface of at least a part of the second transport path and in a second open state, opens at least the part of the second transport path.

According to the present aspect, at least a part of the second transport path is positioned below at least a part of the first transport path. However, since the second path forming section is openable and closable, it is possible to remove the medium jammed in the second transport path by setting the second path forming section to the second open state.

Note that the present aspect is not limited to the first aspect above and may be dependent on any of the second to fifth aspects above.

A seventh aspect is an aspect according to the sixth aspect, wherein the second path forming section pivots coaxially with the first path forming section.

According to the present aspect, since the second path forming section pivots coaxially with the first path forming section, it is possible to close the second path forming section without applying excessive force to the second path forming section by closing the first path forming section in a state where the first path forming section and the second path forming section are opened.

An eighth aspect is an aspect according to the sixth aspect, wherein a part of the transport path is constituted by a third transport path, the pull-out unit has an openable and closable third path forming section, and the third path forming section in a third closed state, forms the lower surface of at least a part of the first transport path and forms an upper surface of at least a part of the third transport path and in a third open state, opens at least the part of the third transport path.

According to the present aspect, at least a part of the third transport path is positioned below at least a part of the first transport path. However, since the third path forming section is openable and closable, it is possible to remove the medium jammed in the third transport path by setting the third path forming section to the third open state.

Note that this present aspect is not limited to the sixth aspect above and may be dependent to the seventh aspect above.

A ninth aspect is an aspect according to the eighth aspect, wherein the second path forming section and the third path forming section do not interfere with each other.

According to the present aspect, since the second path forming section and the third path forming section do not interfere with each other, it is possible to independently open and close each of the second path forming section and the third path forming section, and usability is improved.

A tenth aspect is an aspect according to the eighth aspect, wherein the third path forming section is configured to open in the opening direction of the first path forming section and when the first path forming section while transitioning from the first open state to the first closed state contacts the third path forming section in the third open state, the first path forming section applies an external force in a closing direction to the third path forming section.

According to the present aspect, when the first path forming section, which transitions from the first open state to the first closed state, is in contact with the third path forming section in the third open state, it is configured to apply an external force in a closing direction to the third path forming section. Therefore, it is possible to suppress damage to the third path forming section due to the first path forming section is in contact with the third path forming section.

Note that the present aspect is not limited to the eighth aspect above and may be dependent on the ninth aspect above.

An eleventh aspect is an aspect according to the eighth aspect, wherein a part of the transport path is constituted by a fourth transport path, the pull-out unit has an openable and closable fourth path forming section, and the fourth path forming section in a fourth closed state, forms the lower surface of at least a part of the first transport path and forms an upper surface of at least a part of the fourth transport path and in a fourth open state, opens at least the part of the fourth transport path.

According to the present aspect, at least a part of the fourth transport path is positioned below at least a part of the first transport path. However, since the fourth path forming section is openable and closable, it is possible to remove the medium jammed in the fourth transport path by setting the fourth path forming section to the fourth open state.

Note that the present aspect is not limited to the eighth aspect above and may be dependent on any one of the first to seventh aspects or the ninth or tenth aspect above.

A twelfth aspect is an aspect according to the eleventh aspect, wherein the fourth path forming section has a region facing and a region not facing the first path forming section and the first path forming section has a restriction section configured to restrict opening of the fourth path forming section while in the first closed state or in a state between the first closed state and the first open state.

In the case where the fourth path forming section has a region that does not face the first path forming section, there is a possibility that the fourth path forming section can be accessed without opening the first path forming section. In this case, the user may try to open the fourth path forming section without opening the first path forming section, and as a result, the first path forming section may be strongly pressed against the fourth path forming section to damage the path forming surface of the fourth path forming section.

However, according to the present aspect, since the first path forming section has the restriction section configured to restrict the opening of the fourth path forming section in the first closed state or in a state between the first closed state and the first open state, it is possible to suppress the above described problem.

A thirteenth aspect is an aspect according to the eleventh aspect, wherein the fourth path forming section that takes the fourth closed state has a guide surface configured to, when the first path forming section changes its posture from the first open state to the first closed state, guide the free end path forming section.

According to the present aspect, since the fourth path forming section that takes the fourth closed state has a guide surface configured to, when the first path forming section changes its posture from the first open state to the first closed state, guide the free end path forming section, the first path forming section can smoothly change its posture toward the first closed state.

Note that the present aspect is not limited to the eleventh aspect above and may be dependent on the twelfth aspect above.

A fourteenth aspect is an aspect according to the eleventh aspect, wherein the fourth transport path is provided with a transport roller pair configured to nip and transport the medium, at least a part of the fourth transport path is formed between the fourth path forming section and a fifth path forming section facing the fourth path forming section, the fourth path forming section has a base section pivotable for switching between the fourth open state and the fourth closed state, a pivot section that is a section facing the fifth path forming section downstream of the fourth transport path from the base section and that is pivotably coupled with respect to the base section, and a pivot section pressing unit configured to press the pivot section toward the fifth path forming section, the transport roller pair is disposed in a region formed by the pivot section and the fifth path forming section in the fourth transport path, and one roller of the transport roller pair is pressed toward the other roller by the pivot section pressing unit.

When the transport roller pair is provided in a region far from a pivot shaft of the fourth path forming section, it is difficult to obtain the nip pressure of the transport roller pair.

According to the present aspect, since the fourth path forming section has the base section, the pivot section, which is pivotable with respect to the base section, and the pivot section pressing unit, which presses the pivot section toward the fifth path forming section, and one roller of the transport roller pair is pressed toward the other roller by the pivot section pressing unit, it is possible to obtain an appropriate nip pressure.

Note that the present aspect is not limited to the eleventh aspect above and may be dependent on the twelfth or thirteenth aspect above.

A fifteenth aspect is an aspect according to the eleventh aspect, wherein the fourth transport path is positioned downstream of the third transport path in the transport direction and the third path forming section has an engagement section configured to, in the third open state, engage with an engaged section of the fourth path forming section in the fourth closed state.

According to the present aspect, the third path forming section has the engaged section configured to engage with an engaged section of the fourth path forming section in the fourth closed state in the third open state, and thus the third open state of the third path forming section can be easily maintained.

Note that the present aspect is not limited to the eleventh aspect above and may be dependent on any of the twelfth to fourteenth aspects above.

A sixteenth aspect is an aspect according to the fifteenth aspect, wherein when the fourth path forming section opens toward the fourth open state while the engagement section that is in an engaged state engages with the engaged section, the engagement section disengages engagement with the engaged section and the third path forming section changes its posture toward the third closed state.

According to the present aspect, when the fourth path forming section opens toward the fourth open state while the engagement section that is in the engaged state engages with the engaged section, the engagement section disengages its engagement with the engaged section and the third path forming section changes its posture toward the third closed state. Therefore, it is possible to close the third path forming section without individually operating the third path forming section, and usability is improved.

A seventeenth aspect is an aspect according to the eleventh aspect, wherein the fourth path forming section is configured to open in the opening direction of the first path forming section and when the first path forming section while transitioning from the first open state to the first closed state contacts the fourth path forming section in the fourth open state, the first path forming section applies an external force in a closing direction to the fourth path forming section.

According to the present aspect, when the first path forming section, which transitions from the first open state to the first closed state, is in contact with the fourth path forming section in the fourth open state, it is configured to apply an external force in a closing direction to the fourth path forming section. Therefore, it is possible to suppress damage to the fourth path forming section due to the first path forming section is in contact with the fourth path forming section.

Note that the present aspect is not limited to the eleventh aspect above and may be dependent on any of the twelfth to sixteenth aspects above.

An eighteenth aspect is an aspect according to the eleventh aspect, wherein the fourth path forming section is configured to open in the opening direction of the second path forming section and when the second path forming section while transitioning from the second open state to the second closed state contacts the fourth path forming section in the fourth open state, the second path forming section applies an external force in a closing direction to the fourth path forming section.

According to the present aspect, when the second path forming section, which transitions from the second open state to the second closed state, is in contact with the fourth path forming section in the fourth open state, it is configured to apply an external force in a closing direction to the fourth path forming section. Therefore, it is possible to suppress damage to the fourth path forming section due to the second path forming section is in contact with the fourth path forming section.

Note that the present aspect is not limited to the eleventh aspect above and may be dependent on any of the twelfth to seventeenth aspects above.

A nineteenth aspect is an aspect according to the eighth aspect, wherein the transport path has a feeding path configured to transport the medium toward the recording section, the first transport path includes at least a part of a switchback path configured to switch back the medium in order to inverse a front and back of the medium recorded by the recording section and at least a part of an inversion path configured to inverse the medium that was switched back in the switchback path and to re-transport it to the feeding path, the second transport path guides the medium recorded by the recording section to the switchback path, and the third transport path guides the medium recorded by the recording section in a discharge direction.

In a configuration where the medium is switched back or inverse, the medium is likely to become clogged. however, according to this aspect, by the operation and effect of the first embodiment described above, it is possible to improve the workability of the user in a state where the first path forming section is opened.

Note that the present aspect is not limited to the eighth aspect above and may be dependent on any of the ninth to eighteenth aspects above.

A twentieth aspect is an aspect according to the nineteenth aspect, wherein the transport path has a switching section configured to selectively switch a transport destination of the medium between the second transport path and the third transport path, the medium entering the third transport path from upstream of the switching section takes a linear shape posture, the medium entering the second transport path from upstream of the switching section is formed into a curved shape, a facing member configured to form the lower surface of the third transport path is provided at a position facing the third path forming section, the switching section has a guide section configured to guide the medium, a cam section configured to support a cam contact member attached to the guide section, a drive section configured to rotate the cam section, and a cam pressing section configured to press the cam contact member toward the cam section, and the switching section is configured to switch between a first guide state in which the cam section supports the cam contact member to guide the medium to the third transport path and a second guide state in which in a state where the cam section and the cam contact member are not in contact with each other, in which the guide section contacts against a part of the facing member due to pressing force of the cam pressing section, and that guides the medium to the second transport path.

In a configuration in which the medium entering the third transport path from upstream of the switching section takes a linear shape posture and the medium entering the second transport path from upstream of the switching section forms a curved shape, an appropriate path needs to be formed when the medium enters the second transport path from upstream of the switching section.

According to the present aspect, in the second guide state of the switching section, the guide section comes into contact with a part of the facing member and guides the medium to the second transport path. Therefore, in a case where the medium enters the second transport path from upstream of the switching section, the path is appropriately formed.

A twenty-first aspect is an aspect according to any one of the eighth aspect to twentieth aspect, further includes a contact section against which the third path forming section in the third closed state contacts in the transport direction, wherein a plurality of ribs are provided on a transport surface that forms the third transport path in the third path forming section along a width direction, which intersects with the transport direction, a notch section into which the contact section enters is formed at an end section in the width direction in the third path forming section, a gap is formed between the downstream end of the transport surface and the contact section in the transport direction, a rib of the plurality of ribs that is positioned at the end section in the width direction has a first section extending along the transport direction and a second section extending from a downstream end of the first section in the transport direction to an outer side in the width direction toward downstream in the transport direction so as to intersect with the transport direction, and at least a part of the second section overlaps the contact section in the width direction.

When the contact section is provided and the gap is formed between the downstream end of the transport surface and the contact section in the transport direction, a corner portion of the leading edge of the medium may enter the gap and contact on the contact section, causing a jam. To suppress such a problem, it is necessary to provide a rib that separates the side edge of the medium from the gap, but when such a rib is provided at a position corresponding to the side edge of the medium, there is also a possibility that the corner portion of the medium may be caught by the rib, leading to a jam.

According to the aspect, the rib, which is among the plurality of ribs, positioned at the end section in the width direction has the first section extending along the transport direction and the second section extending from downstream end of the first section in the transport direction to the outer side in the width direction toward the downstream in the transport direction so as to intersect with the transport direction, and the second section at least partially overlaps with the contact section in the width direction. Therefore, it is possible to prevent the corner of the leading edge of the medium from entering the gap by the second section and coming into contact with the contact section, thereby preventing the occurrence of a jam. In addition, since the second section extends to the outer side in the width direction toward the downstream in the transport direction so as to intersect with the transport direction, it is also possible to prevent the corner of the leading edge of the medium from being caught by the second section, that is, it is possible to prevent the occurrence of a jam.

Hereinafter, the present disclosure will be described in detail.

Hereinafter, an inkjet printer 1 that performs recording by ejecting ink, which is an example of liquid, onto a medium represented by a recording paper sheet, will be described as an example of a recording device. Hereinafter, the inkjet printer 1 will be referred to simply as a printer 1.

The recording device is not limited to the inkjet printer. Examples of the recording device include various printers such as a laser printer, a dot impact printer, and a thermal printer.

An X-Y-Z coordinate system shown in each drawing is an orthogonal coordinate system, and a Y-axis direction is a medium width direction, which intersects with a transport direction of the medium and is a device depth direction. Among side surfaces constituting the periphery of a housing 2 in the present embodiment, the side surface in a +Y direction is a back surface and the side surface in a −Y direction is a front surface.

An X-axis direction is a device width direction and as viewed from an operator of the printer 1, a +X direction is the left side and a −X direction is the right side. The −X direction is a medium send out direction from each medium cassette (to be described later).

A Z-axis direction is a vertical direction, that is, a device height direction, and a +Z direction is an upward direction and a −Z direction is a downward direction.

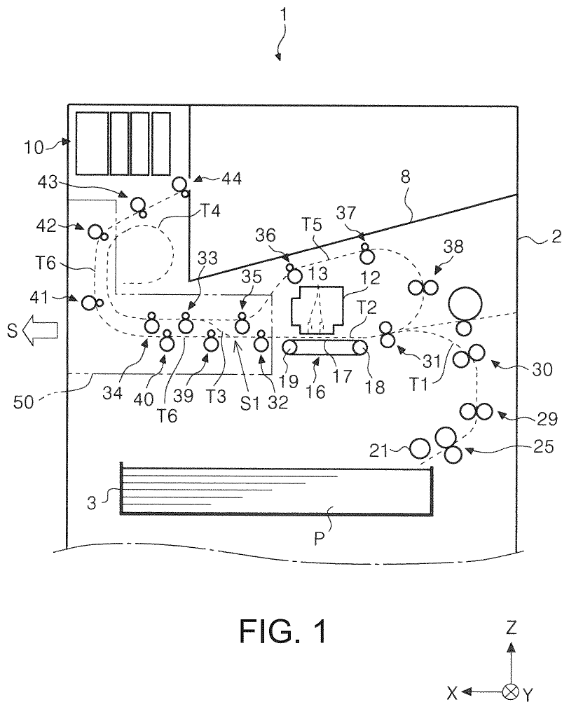

Hereinafter, a direction in which the medium is sent may be referred to as “downstream”, and an opposite direction of it may be referred to as “upstream”. In FIG. 1, a transport path of the medium is indicated by dashed line. In the printer 1, the medium is transported through the transport path indicated by the dashed line. In FIG. 1, reference symbols T1, T2, T3, T4, T5, and T6 denote the transport paths. The transport paths will be described later.

The printer 1 includes a medium cassette 3 at a lower part of the housing 2 that includes a line head 12 (to be described later). The symbol P indicates a medium accommodated in the medium cassette 3.

The medium cassette 3 is provided with a pickup roller 21 for feeding out the accommodated medium in the −X direction. The medium cassette 3 is provided with a feed roller pair 25 that further feeds the medium sent out by the pickup roller 21 downstream. Note that a plurality of medium cassettes (not shown) are further provided below medium cassette 3. A pickup roller (not shown) and a feed roller pair (not shown) are provided for each of the plurality of medium cassettes (not shown).

Note that in the following description, unless otherwise specifically described, the term “roller pair” is assumed to be composed of a drive roller driven by a power source such as a motor and a driven roller that is in contact with the drive roller and driven to rotate.

The reference symbol T1 indicates the transport path, in other words, a feeding path, of the medium sent out from the medium cassette 3 and reaching a transport roller pair 31. The medium sent out from the medium cassette 3 is sent to the transport roller pair 31 by receiving sending force from the transport roller pairs 29 and 30. In the present embodiment, the feeding path T1 is a path from the medium cassette 3 to the transport roller pair 31.

The medium receiving the sending force from the transport roller pair 31 is sent to the transport path T2. In the transport path T2, the line head 12, which is an example of a recording section, and a transport belt 17 are provided. A position facing the line head 12 on the transport path T2 is a recording position. In the present embodiment, the transport path T2 is a linear shape path extending from the transport roller pair 31 to a transport roller pair 32.

The line head 12 has nozzles 13, and performs recording by ejecting ink from the nozzles 13 onto the medium. In the present embodiment, an ejection direction of ink from the nozzle 13 is the −Z direction. The line head 12 is an ink ejection head in which the nozzles 13 for ejecting ink are disposed so as to cover the entire area in the medium width direction and is configured as the ink ejection head capable of recording in the entire width of the medium without moving in the medium width direction. However, the ink ejection head is not limited to this, and may be of a type that is mounted on a carriage and that ejects ink while moving in the medium width direction.

The line head 12 according to the present embodiment ejects, as an example, plural colors of ink. Specifically, in the present embodiment, the plurality of nozzles 13 are composed of a plurality of nozzles 13 for ejecting yellow ink, a plurality of nozzles 13 for ejecting magenta ink, a plurality of nozzles 13 for ejecting cyan ink, and a plurality of nozzles 13 for ejecting black ink.

The transport belt 17 is an endless belt that is looped around a first roller 18, which is a drive roller, and a second roller 19, which is a driven roller, and rotates when the first roller 18 is driven by a motor (not shown). The medium is transported through the position facing the line head 12 while being attracted to a belt surface of the transport belt 17.

The first roller 18, the second roller 19, and the transport belt 17 constitute a belt unit 16.

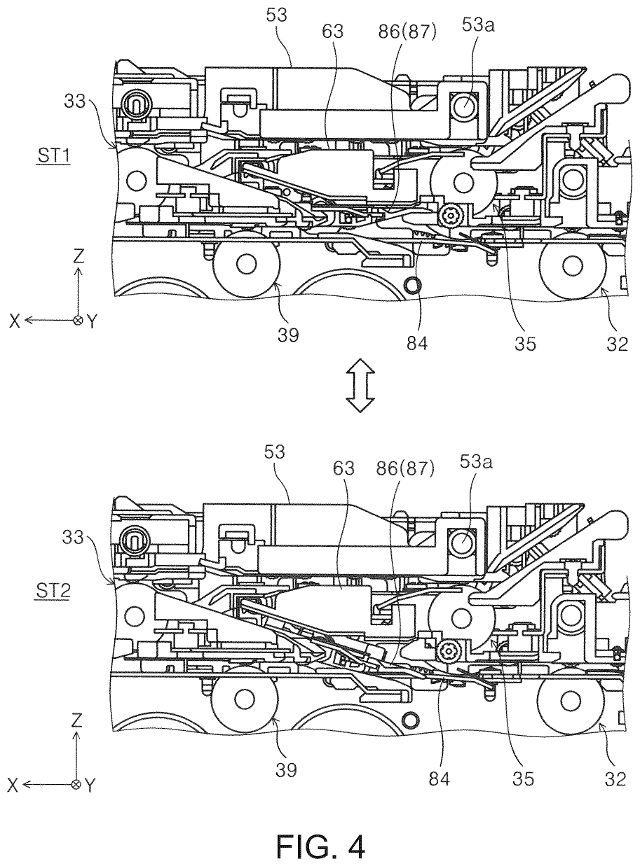

The medium on which recording has been performed by the line head 12 is sent by the transport roller pair 32 positioned downstream of the belt unit 16 toward either a transport roller pair 33 or a transport roller pair 39. Symbol S1 is a branch position of the transport path, and a switching section 86 for switching the transport path (see FIG. 4) is provided at this branch position S1. The switching section 86 will be described later.

The medium has a first surface and a second surface opposite to the first surface, and the medium is sent to the discharge path T6 when recording is first performed on the first surface, in a case where the medium is discharged without performing recording on the second surface, or in a case where recording is performed on the second surface and the medium is discharged. In the present embodiment, the discharge path T6 is a path extending from the transport roller pair 32 to a transport roller pair 44 via transport roller pairs 39, 40, 41, 42, and 43. The discharge path T6 is shaped to curve and inverse the medium so that the surface on which the recording has been most recently performed is on the inside.

The medium sent to the discharge path T6 is discharged face-down toward a discharge tray 8 by the transport roller pair 44. Note that the transport path may be further branched in the discharge path T6. For example, in addition to the path for discharging the medium face-down as shown, a path for discharging the medium face-up to a discharge tray (not shown) or another device may be provided.

When recording is performed on the second surface of the medium, that is, when double-sided recording is to be performed, the medium is sent to the guide path T3. In the present embodiment, the guide path T3 is a path from the transport roller pair 32 to the transport roller pair 33.

The medium is further sent to the switchback path T4 by the transport roller pair 33. In the present embodiment, the switchback path T4 is a path in the +X direction from the transport roller pair 33. The switchback path T4 is shaped to curve and inverse the medium so that the surface on which the recording has been most recently performed is on the inside. The switchback path T4 is a path for switching back the medium recorded by the line head 12 in order to inverse the front and back of the medium. The switchback path T4 is further provided with a transport roller pair 34 in addition to the transport roller pair 33.

When the medium enters the switchback path T4, the rotational directions of the transport roller pairs 33 and 34 are switched, and the medium is sent in the −X direction and enters the inversion path T5.

In the present embodiment, the inversion path T5 is a path from the transport roller pair 33 to the transport roller pair 31 via transport roller pairs 35, 36, 37, and 38. The inversion path T5 passes above the line head 12, and is shaped to curve and reverse the medium so that the surface on which recording has been most recently performed is on the outside. The inversion path T5 is a path for inversing the medium switched back in the switchback path T4 and re-transporting the medium to the feeding path T1.

The medium sent to the inversion path T5 enters the feeding path T1 upstream of the transport roller pair 31, and recording is performed by the line head 12.

Note that reference symbol 10 indicates ink containers as liquid containers for containing ink before ejection. Ink to be ejected from the line head 12 is supplied from the ink container 10 to the line head 12 through a tube (not shown). The ink container 10 contains, for example, black, yellow, magenta, and cyan inks.

The overall configuration of the printer 1 has been described above and a pull-out unit 50 will be described in detail below. The pull-out unit 50 is provided on a left side surface, which is a side surface in the +X direction, of the housing 2. The pull-out unit 50 can be pulled out from housing 2 in the direction indicated by an arrow S, that is, in the +X direction, and can be accommodated in the −X direction, that is, in the accommodation direction, from a pulled out state.

When the pull-out unit 50 is pulled out, the transport path T2, the switchback path T4, the inversion path T5, and the discharge path T6 are divided. Specifically, when the pull-out unit 50 is pulled out, the transport path T2 is divided between the belt unit 16 and the transport roller pair 32, and the inversion path T5 is divided between the transport roller pair 35 and the transport roller pair 36. When the pull-out unit 50 is pulled out, the discharge path T6 is divided between the transport roller pair 42 and the transport roller pair 43, and the switchback path T4 is divided at a position in the +X direction and the +Z direction of the transport roller pair 34.

That is, the pull-out unit 50 can pull out a part of the transport path of the printer 1 with respect to the housing 2, and when the pull-out unit 50 is pulled out, it is possible to open each path forming section (to be described later), and thus, it is possible to remove medium jammed in each path.

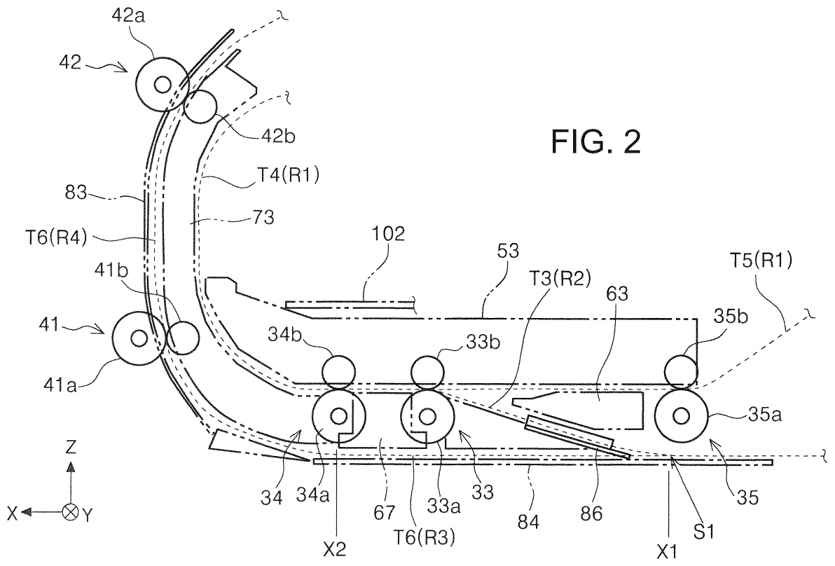

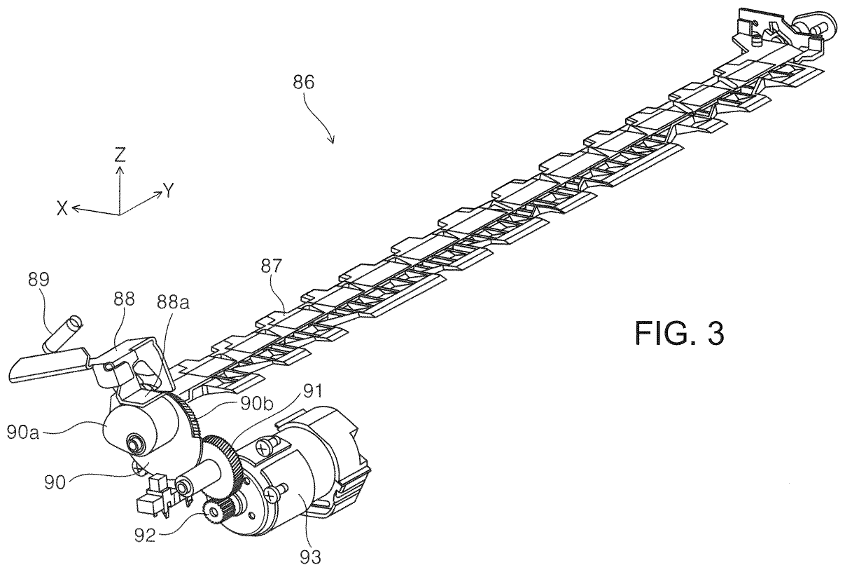

Referring to FIG. 2, each path forming section included in the pull-out unit 50 will be generally described. FIG. 2 shows the shape of each path forming section generally by two-dot chain line and all the path forming sections in a closed state. Note that FIG. 3 and the following are diagrams showing the configuration of the pull-out unit 50 in detail, and the shape of each component part, the relative positional relationship, and the relative size relationship between the plurality of component parts are as shown in the drawings.

A first path forming section 53 forms an upper surface of a part of the switchback path T4 and a part of the inversion path T5. When the transport path including the switchback path T4 and the inversion path T5 is referred to as a first transport path R1, the first path forming section 53 is a section that forms the upper surface of a part of the first transport path R1 in a closed state and opens a part of the first transport path R1 in the opened state.

A state in which the first path forming section 53 is maximally closed in the openable and closable range is referred to as a first closed state, and a state in which the first path forming section 53 is opened is referred to as a first open state.

A second path forming section 63 is positioned below the first path forming section 53. The second path forming section 63 forms the lower surface of a part of the inversion path T5 of the first transport path R1 and forms the upper surface of a part of the guide path T3. Assuming that the guide path T3 is a second transport path R2, the second path forming section 63 is a section that forms the lower surface of a part of the first transport path R1 and forms the upper surface of a part of the second transport path R2 in the closed state.

A state where the second path forming section 63 is maximally closed within the openable and closable range is referred to as a second closed state, and a state where the second path forming section 63 is opened is referred to as a second open state.

A third path forming section 67 is positioned below the first path forming section 53. Assuming that a section of the discharge path T6 from position X1, which is the X-axis direction position of branch position S1, to position X2, which is the X-axis direction position of the transport roller pair 34, is a third transport path R3, the third transport path R3 is a path that guides the medium recorded on by the line head 12 in the discharge direction.

In the closed state, the third path forming section 67 forms the lower surface of a part of the first transport path R1 and forms the upper surface of a part of the third transport path R3.

A state where the third path forming section 67 is maximally closed within the openable and closable range is referred to as a third closed state, and a state where the third path forming section 67 is opened is referred to as a third open state.

A fourth path forming section 73 is positioned in the +X direction with respect to the third path forming section 67, and a part thereof is positioned below the first path forming section 53. Assuming that the section of the discharge path T6 downstream from position X2 is a fourth transport path R4, in the closed state the fourth path forming section 73 forms the lower surface of a part of the first transport path R1 and forms the upper surface of a part of the fourth transport path R4. The fourth path forming section 73 opens a part of the fourth transport path R4 in the open state.

A state where the fourth path forming section 73 is maximally closed within the openable and closable range is referred to as a fourth closed state, and a state where the fourth path forming section 73 is opened is referred to as a fourth open state.

In the present embodiment, the second path forming section 63 and the third path forming section 67 are entirely positioned below the first path forming section 53 and a part of the fourth path forming section 73 is positioned below the first path forming section 53. Therefore, when each path forming section is opened by pulling out the pull-out unit 50, the first path forming section 53 is opened first. By this, each of the second path forming section 63, the third path forming section 67, and the fourth path forming section 73 can be opened.

Note that in the present embodiment, after the first path forming section 53 is opened, the second path forming section 63, the third path forming section 67, and the fourth path forming section 73 can be opened independently, or any two or all of them can be opened. When any two of the second path forming section 63, the third path forming section 67, and the fourth path forming section 73 are opened, all combinations are possible.

Note that as will be described later in detail, when the fourth path forming section 73 is opened in the present embodiment, the third path forming section 67 can be opened from the third closed state to the third open state but cannot be maintained in the third open state. Both the second path forming section 63 and the fourth path forming section 73 can maintain the open state without being affected by the other path forming sections.

Next, the switching section 86 described above is provided below the second path forming section 63. The switching section 86 selectively switches the transport destination of the medium to the second transport path R2 and the third transport path R3. The switching section 86 will be described below with reference to FIG. 3 to FIG. 6.

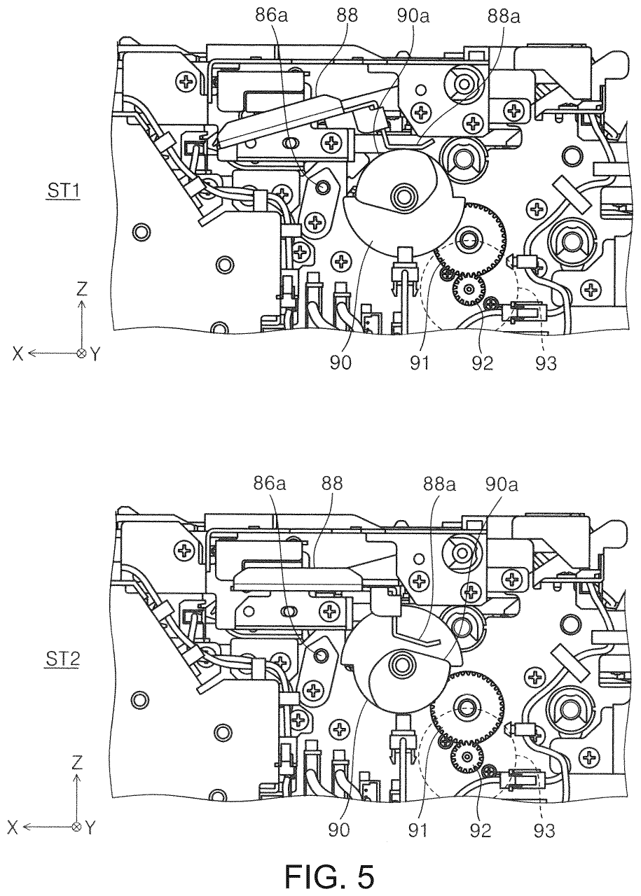

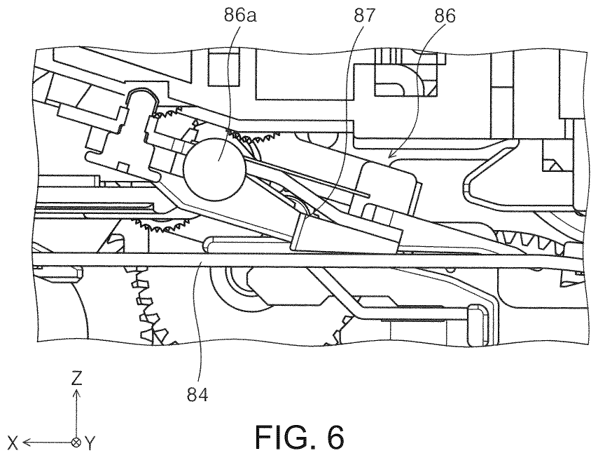

The switching section 86 has a guide section 87 that switches the transport destination of the medium. The guide section 87 extends in the Y-axis direction, that is, the medium width direction. The guide section 87 is provided so as to be pivotable around a pivot shaft 86a (see FIG. 6). The pivot shaft 86a has an axis center parallel to the Y-axis direction. A state ST1 in FIG. 4 and FIG. 5 shows a first guide state of the switching section 86. In the first guide state, the switching section 86 guides the medium to the third transport path R3. Since the medium entering the third transport path R3 from upstream of the switching section 86 advances linearly, it takes a linear shape posture.

A state ST2 in FIG. 4 and FIG. 5 and a state in FIG. 6 show the second guide state of the switching section 86. In the second guide state, the switching section 86 guides the medium to the second transport path R2. Since the medium entering the second transport path R2 from upstream of the switching section 86 changes its traveling direction upward, the medium is formed in a curved shape.

In FIG. 3, a cam contact member 88 is provided at an end section in the −Y direction of the guide section 87, and the guide section 87 and the cam contact member 88 pivot integrally. One end of a tension spring 89, which is an example of a cam pressing section, is provided on the cam contact member 88, and the other end of the tension spring 89 is provided on an engagement section (not shown). The tension spring 89 presses the guide section 87 toward the second guide state.

The cam contact member 88 is provided with a cam contact section 88a.

A cam section 90a is disposed at a position facing the cam contact section 88a. The cam section 90a is provided integrally with a cam gear 90.

The cam gear 90 is provided with a gear section 90b, which meshes with a gear 91. A pinion 92 provided on a drive shaft of a motor 93 meshes with the gear 91. By this, when the motor 93 rotates, power is transmitted to the cam gear 90 via the gear 91, and the cam gear 90 rotates, that is, the cam section 90a rotates. The motor 93 is an example of a drive section configured to rotate the cam section 90a.

As shown in the state ST1 in FIG. 3 and FIG. 5, the switching section 86 takes the first guide state by the cam section 90a supports the cam contact section 88a. When the cam contact section 88a is in a state of not contacting the cam section 90a as shown in the state ST2 of FIG. 5 due to the rotation of the cam section 90a, the guide section 87 is brought into contact with a part of a facing member 84 by the spring force of the tension spring 89 as shown in FIG. 6, and the switching section 86 takes the second guide state. The facing member 84 is a member that forms a lower surface of the third transport path R3.

With such a configuration, the following operations and effects can be obtained. When the medium enters the second transport path R2 from upstream of the switching section 86, in a configuration that forms a curved shape in the medium, a path must be formed appropriately.

In the present embodiment, in the second guide state of the switching section 86, the guide section 87 contacts against a part of the facing member 84 and guides the medium to the second transport path R2, and thus, when the medium enter the second transport path R2 from upstream of the switching section 86, the path is appropriately formed.

Since the path is switched by the motor 93, the speed of the path switching can be increased as compared with the configuration in which the path is switched by a solenoid.

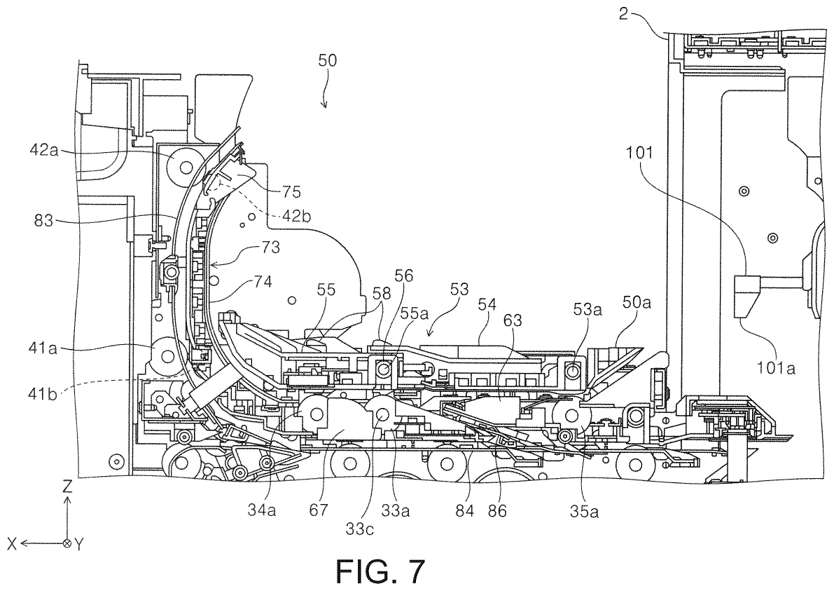

Next, the opening and closing of each path forming section will be described with reference to FIG. 7 and the subsequent drawings.

FIG. 7 shows a state in which the pull-out unit 50 is pulled out from the housing 2 in the +X direction and all the path forming sections are closed.

The first path forming section 53 is opened and closed by pivoting around a pivot shaft 53a. Note that in the present embodiment, all the path forming sections are opened and closed by pivoting around a pivot shaft, and the pivot shaft has an axis center line parallel to the Y-axis direction. In the present embodiment, all the path forming sections open in the same direction and close in the same direction. Specifically, all the path forming sections are opened by pivoting in a clockwise direction from the state of FIG. 7, and closed by pivoting from the open state in a counterclockwise direction of FIG. 7. In the present embodiment, all the path forming sections are in contact with the contact sections opposing the path forming sections in the closed state, and thus the pivoting in the closing direction is restricted.

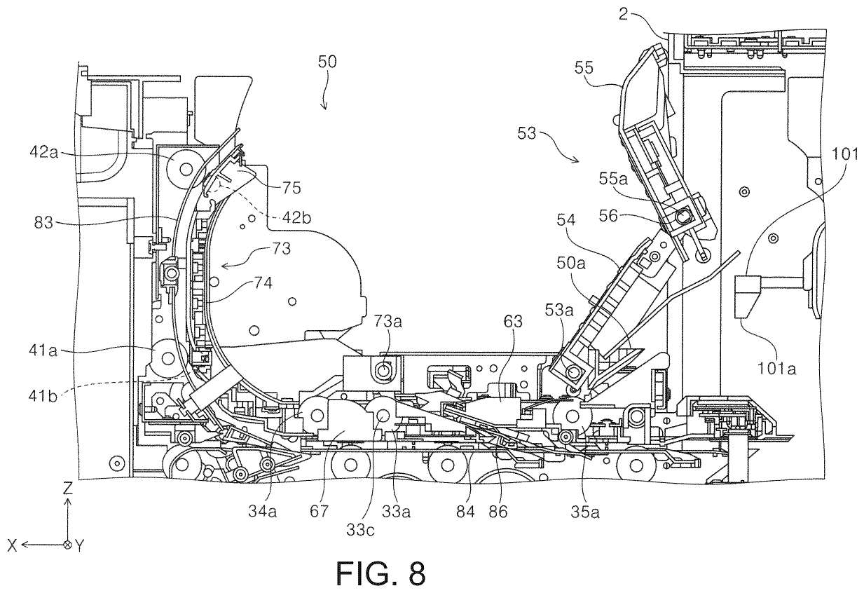

FIG. 8 is a view in which the first path forming section 53 is opened from the state of FIG. 7 to be in the first open state. By setting the first path forming section 53 to the first open state, it is possible to remove the medium jammed in the first transport path R1 (see FIG. 2).

The first path forming section 53 has a base end path forming section 54, which is the section on the base end side during opening and closing, and a free end path forming section 55, which is the section on the free end side during opening and closing and is pivotably coupled to the base end path forming section 54. Reference symbol 55a is a pivot shaft of the free end path forming section 55. The pivot shaft 55a has an axis center line parallel to the Y-axis direction. The base end path forming section 54 pivots around the pivot shaft 53a.

As described above, since the first path forming section 53 has the base end path forming section 54, which is the section on the base end side during opening and closing, and the free end path forming section 55, which is the section on the free end side during opening and closing and which is pivotably coupled to the base end path forming section 54, it is possible to improve the degree of freedom of the posture of the first path forming section 53 and to improve the workability of the user in a state where the first path forming section 53 is opened.

More specifically, the larger the path forming section, the wider the path range that can be opened, but the opening direction of the first path forming section 53 is a direction toward the housing 2, and the longer the distance from the pivot shaft 53a to the free end, the easier it is for the first path forming section 53 to contact against the housing 2. At this time, if the first path forming section 53 is an integral configuration, the opening angle of the first path forming section 53 is limited by contact with the housing 2, and a work area for clearing the paper jam becomes narrow.

However, in the configuration where the first path forming section 53 has the base end path forming section 54 and the free end path forming section 55 as in the present embodiment, when the first path forming section 53 is opened from the first closed state toward the first open state, after the free end path forming section 55 is in contact with a part of the housing 2, the free end path forming section 55 and the base end path forming section 54 pivot relative to each other, allowing the base end path forming section 54 to open further in the opening direction.

By this, the work area for clearing the paper jam is expanded, and the workability of the user is improved.

Note that although the first path forming section 53 includes one free end path forming section 55 in the present embodiment, a plurality of free end path forming sections may be coupled.

It is also desirable to provide a driven roller at a section of the free end path forming section 55, which is in contact with the housing 2. By this, when the free end path forming section 55 slides with the housing 2, it can slide smoothly with the housing 2.

Note that in the present embodiment, the opening limit of the base end path forming section 54 is restricted by the base end path forming section 54 being in contact with a restriction section 50a of the pull-out unit 50. However, the first open state, that is, the fully open state, of the first path forming section 53 may be maintained by the free end path forming section 55 contacting the housing 2 and pivoting the free end path forming section 55 to its counterclockwise pivot limit in FIG. 8.

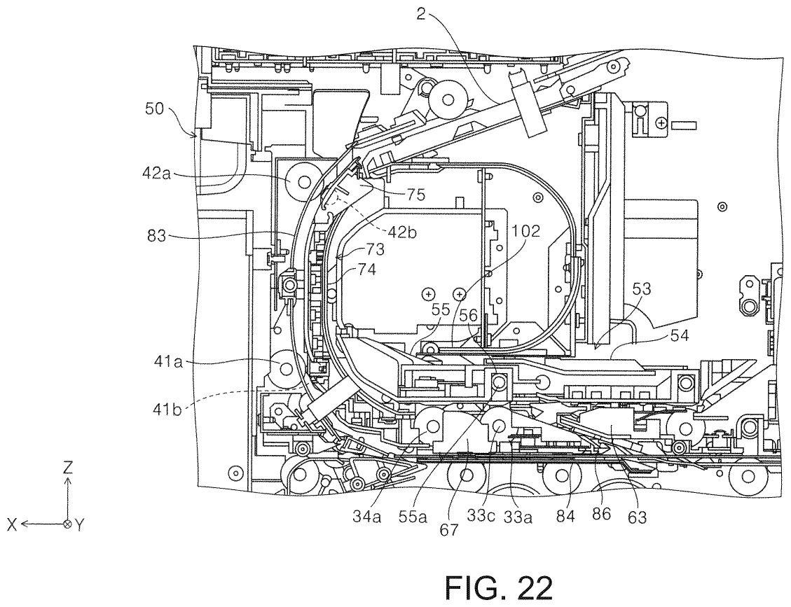

Note that the pivot limit in the clockwise direction of FIG. 8 of the free end path forming section 55 is restricted by a restriction section (not shown). When the free end path forming section 55 is pivoted the maximum in the clockwise direction in FIG. 8, the base end path forming section 54 and the free end path forming section 55 become linear shape, as shown in FIG. 7 and FIG. 22.

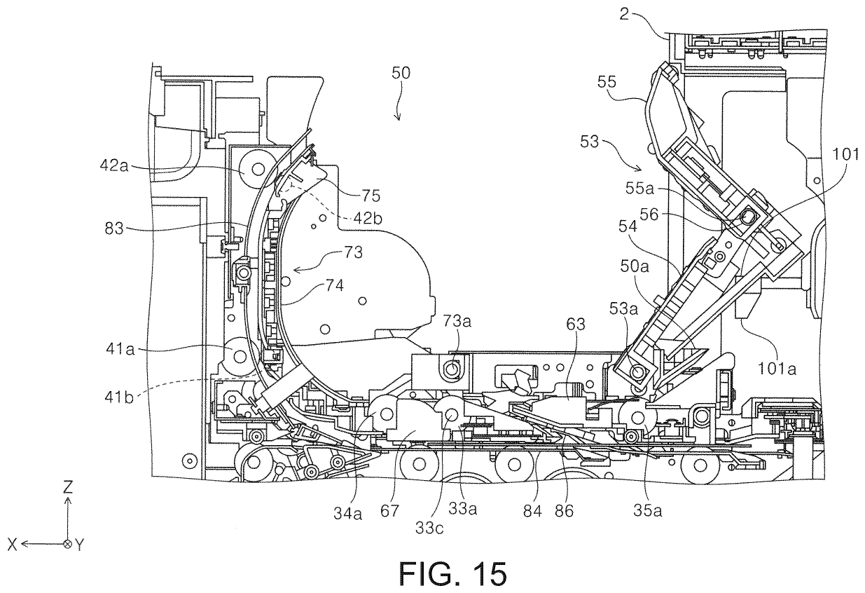

The pivot limit in the counterclockwise direction of FIG. 8 of the free end path forming section 55 is restricted by a restriction section (not shown). When the free end path forming section 55 is pivoted to the maximum in the counterclockwise direction in FIG. 8, the base end path forming section 54 and the free end path forming section 55 are substantially perpendicular to each other as shown in FIG. 15.

Next, the first path forming section 53 further has a torsion spring 56, which is a biasing member for urging the free end path forming section 55 in the clockwise direction in FIG. 8, that is, in the opening direction. By this, in the first open state of the first path forming section 53, the free end path forming section 55 can be prevented from closing in the counterclockwise direction in FIG. 8, that is, in the closing direction. For this reason, it is possible to suppress narrowing of the open region when the first path forming section 53 is opened.

Note that when the spring force of the torsion spring 56 is strong, the base end path forming section 54 and the free end path forming section 55 form a linear shape, and thus, the spring force of the torsion spring 56 is desirably set to a magnitude capable of maintaining the first open state shown in FIG. 8, that is, the state in which the first path forming section 53 is bent.

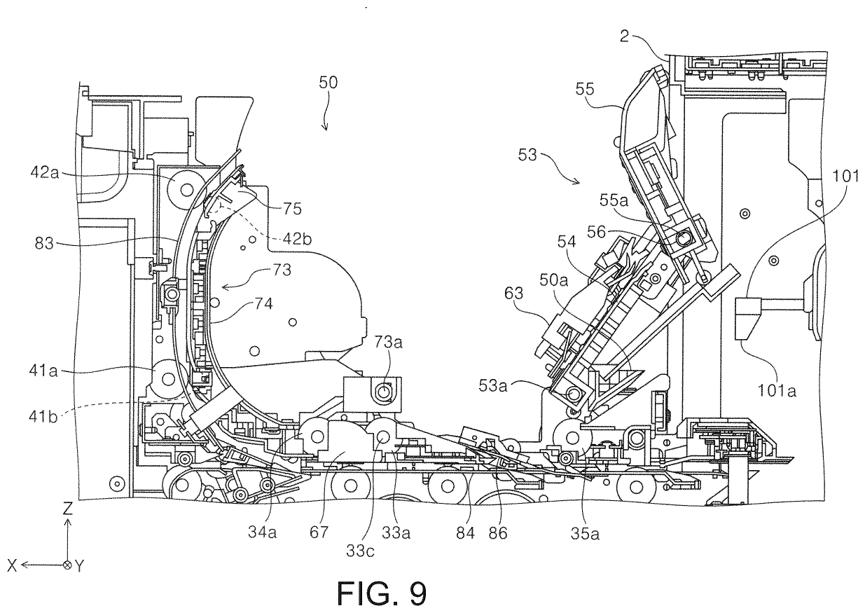

Next, FIG. 9 shows a state where the first path forming section 53 is in the first open state and the second path forming section 63 is in the second open state. As described above, in the second closed state, the second path forming section 63 forms the lower surface of a part of the first transport path R1 (see FIG. 2) and forms an upper surface of a part of the second transport path R2 (see FIG. 2). Therefore, by setting the second path forming section 63 to the second open state, it is possible to remove the medium jammed in the second transport path R2.

In the present embodiment, the second path forming section 63 opens and closes by pivoting around the pivot shaft 53a. That is, the second path forming section 63 pivots coaxially with the first path forming section 53. Accordingly, by closing the first path forming section 53 from the state of FIG. 9, that is, the state in which the first path forming section 53 and the second path forming section 63 are opened, it is possible to close the second path forming section 63 without applying excessive force to the second path forming section 63.

Note that in the present embodiment, the second path forming section 63 is configured to be supported in the second open state by the first path forming section 53 in the first open state. However, it is a matter of course that a section for supporting the second path forming section 63 in a state where the second path forming section 63 is opened may be separately provided.

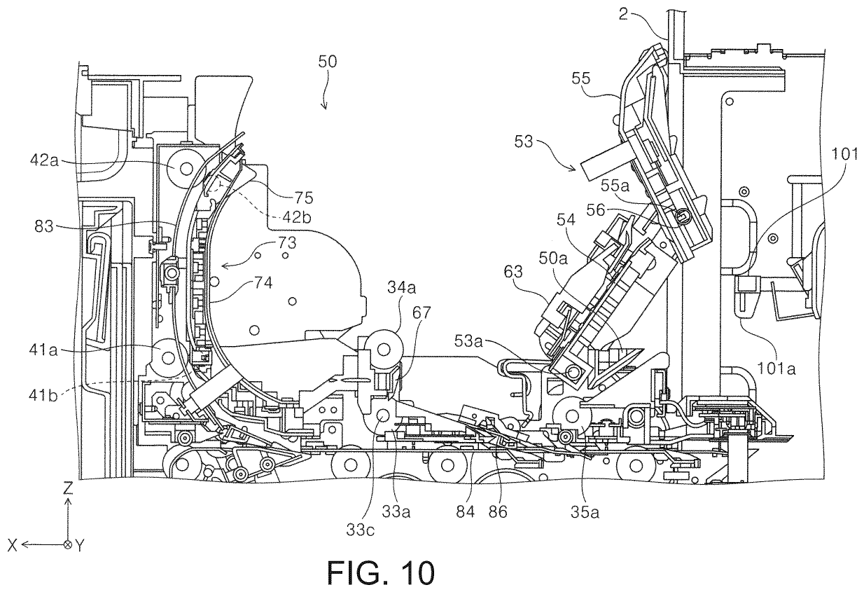

Next, FIG. 10 shows a state where the third path forming section 67 is in the third open state. By setting the third path forming section 67 to the third open state, it is possible to open a part of the third transport path R3 (refer to FIG. 2) and it is possible to remove medium jammed in the third transport path R3.

In the present embodiment, the third path forming section 67 uses a rotation shaft 33c of a drive roller 33a that constitutes the transport roller pair 33 as a pivot shaft. The third path forming section 67 supports a drive roller 34a that constitutes the transport roller pair 34.

Note that a driven roller 33b (see FIG. 2) that constitutes the transport roller pair 33 and a driven roller 34b (see FIG. 2) that constitutes the transport roller pair 34 are supported by the free end path forming section 55 that constitutes the first path forming section 53.

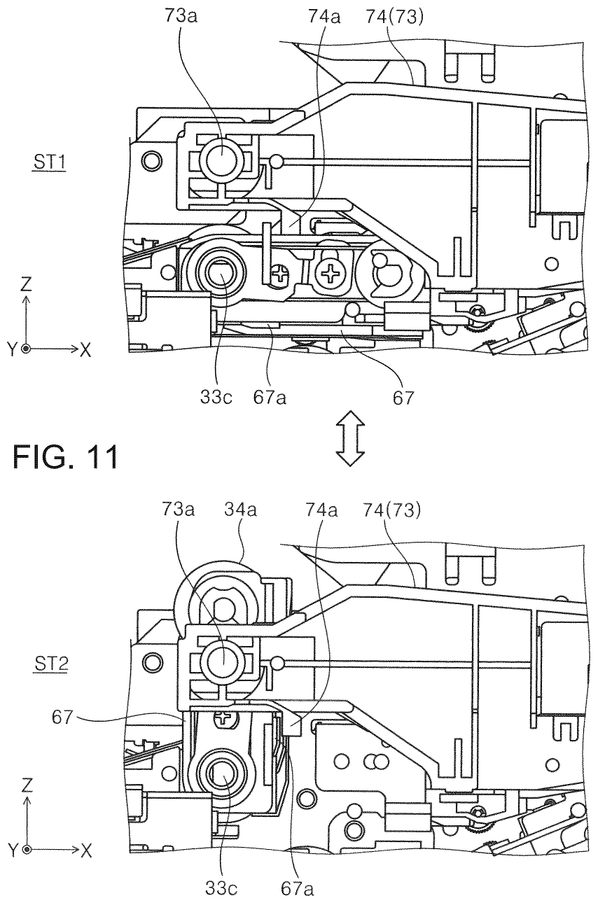

In the present embodiment, as described above, the third path forming section 67 opens in the same direction as the first path forming section 53. In the third open state of the third path forming section 67, the position of the center of gravity of the third path forming section 67 (not shown) is positioned closer to the closing side, that is, +X direction than the axis center of the rotation shaft 33c, and the third path forming section 67 attempts to close. However, as shown in state ST2 of FIG. 11, an engaged section 74a provided in the fourth path forming section 73 and a engagement section 67a provided in the third path forming section 67 (to be described later) engage with each other, so that the third open state of the third path forming section 67 is maintained. Note that FIG. 11 is a view seen from a direction opposite to FIG. 10 in the Y-axis direction.

More specifically, a base section 74 constituting the fourth path forming section 73 is provided with the engaged section 74a. The engaged section 74a is elastically deformable. In the state ST1 of FIG. 11, the fourth path forming section 73 is in the fourth closed state, and the third path forming section 67 is in the third closed state. In a process in which the third path forming section 67 is opened from this state, the engagement section 67a of the third path forming section 67 elastically deforms the engaged section 74a and pushes it aside, and the engagement section 67a can ride over the engaged section 74a in the −X direction as shown in the state ST2 of FIG. 11. By this, the third open state of the third path forming section 67 can be easily maintained.

Note that when the fourth path forming section 73 is opened toward the fourth open state in the state ST2 of FIG. 11, that is, in the state in which the engagement section 67a and the engaged section 74a are engaged, the engagement section 67a disengages the engagement with the engaged section 74a, and the third path forming section 67 changes its posture toward the third closed state. When the fourth path forming section 73 opens toward the fourth open state while in a state where the engagement section 67a and the engaged section 74a are engaged, the engaged section 74a is displaced in the +Z direction and is separated from the engagement section 67a. In this manner, as the engaged section 74a is separated from the engagement section 67a, the engagement between the engagement section 67a and the engaged section 74a is disengaged, and the third path forming section 67 changes its posture toward the third closed state. By this, the third path forming section 67 can be closed without being individually operated, and usability is improved.

Note that, in the present embodiment, the second path forming section 63 and the third path forming section 67 are configured not to interfere with each other. By this, each of the second path forming section 63 and the third path forming section 67 can be opened and closed independently, and usability is improved.

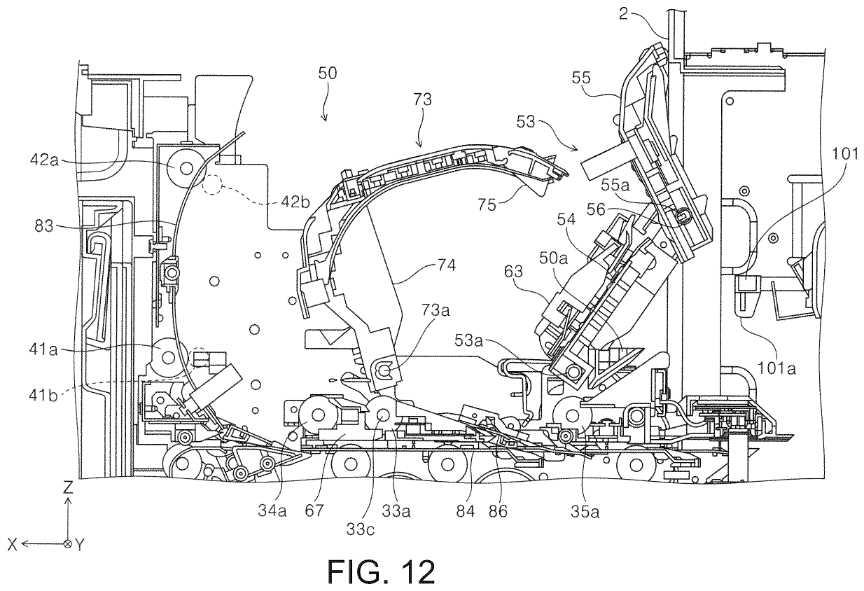

Next, FIG. 12 shows a state where the first path forming section 53 is in the first open state, the second path forming section 63 is in the second open state, and the fourth path forming section 73 is in the fourth open state. By setting the fourth path forming section 73 to the fourth open state, it is possible to open the fourth transport path R4 (see FIG. 2) and it is possible to remove the medium jammed in the fourth transport path R4.

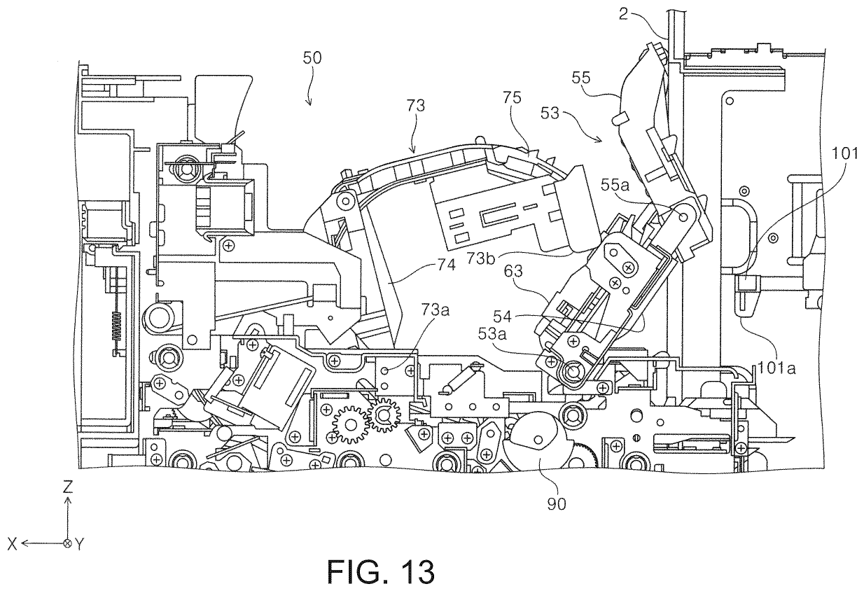

Here, in the present embodiment, the fourth open state of the fourth path forming section 73 has two forms, and one form is a case where the second path forming section 63 is in the second open state as shown in FIG. 12. FIG. 13 is a cross-sectional view cut at a position different from that of FIG. 12 in the same open and closed state as that of FIG. 12. Although not shown in FIG. 12, as shown in FIG. 13, a free end of the fourth path forming section 73 is provided with a handle section 73b, which serves as a handle for opening and closing an end section in the −Y direction, and the handle section 73b is able to contact against the second path forming section 63 in the second open state. In this state, the position of the center of gravity (not shown) of the fourth path forming section 73 is in the opening direction, that is, the −X direction with respect to the axis center of a pivot shaft 73a, whereby the fourth path forming section 73 is supported by the second path forming section 63 in the second open state and the fourth open state can be maintained.

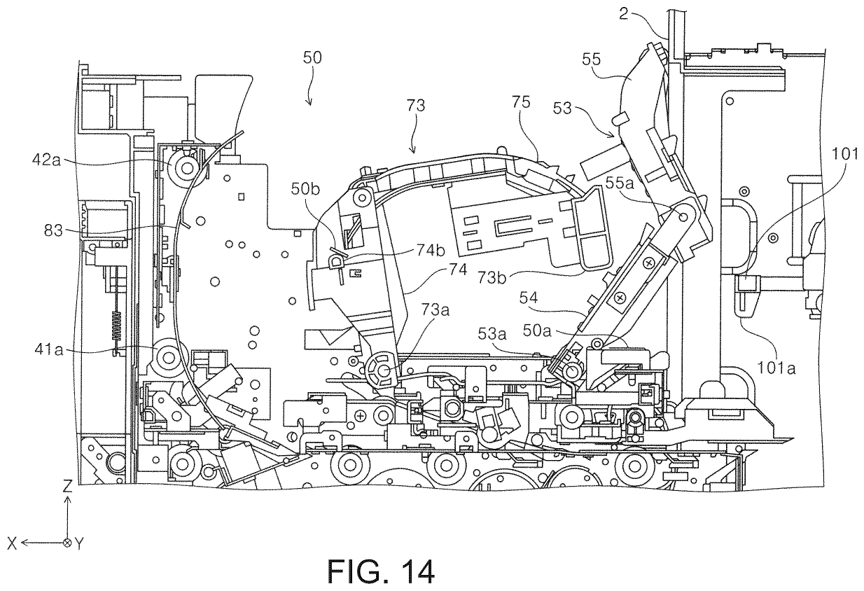

Another form of the fourth open state of the fourth path forming section 73 is a case where the second path forming section 63 is in the second closed state as shown in FIG. 14. In this state, the handle section 73b cannot contact the second path forming section 63 and does not contact the first path forming section 53.

The pull-out unit 50 is provided with a restriction section 50b, and when the second path forming section 63 is in the second closed state, a contact section 74b provided in the fourth path forming section 73 can contact with the restriction section 50b from below. In this state, the position of the center of gravity (not shown) of the fourth path forming section 73 is in the opening direction, that is, the −X direction with respect to the axis center of the pivot shaft 73a, whereby the pivoting of the fourth path forming section 73 in the opening direction is stopped by the restriction section 50b, and the fourth path forming section 73 maintains the fourth open state. The restriction section 50b is positioned at a position deviated from the medium transport region in the Y-axis direction and, specifically, protrudes in the +Y direction from an end section in the −Y direction.

However, when the second path forming section 63 is in the second closed state, the fourth path forming section 73 may be supported by the first path forming section 53 in the first open state.

The above is a basic opening and closing operation of each path forming section, and hereinafter, an operation of each path forming section when the pull-out unit 50 is accommodated in the housing 2 while each path forming section is in an open state will be described. When the pull-out unit 50 is to be accommodated in the housing 2, it is desirable that all the path forming sections are closed by the user. However, some users may store the pull-out unit 50 in the housing 2 with one or a plurality of the path forming sections left in the open state, and in this case, there is a possibility that the open path forming sections are broken. However, the pull-out unit 50 according to the present embodiment is configured to suppress breakage of each path forming section even when such an irregular operation is performed.

Hereinafter, each pattern of the irregular operation will be described.

FIG. 15 to FIG. 21 show a process of accommodating the pull-out unit 50 in the −X direction, that is, the accommodation direction from the state shown in FIG. 8, that is, the state where the first path forming section 53 is in the first open state and the other path forming sections are in the closed state. The housing 2 is provided with a contact rod 101, which is an example of a first contact section capable of contacting the base end path forming section 54 in an open state, along with the accommodation direction displacement of the pull-out unit 50. On the lower side of the contact rod 101, an extension section 101a is formed so as to extend in the −Z direction.

When the pull-out unit 50 is displaced in the accommodation direction from the state of FIG. 8, since the free end path forming section 55 is in a state of being in contact with the housing 2 by the spring force of the torsion spring 56, the base end path forming section 54 and the free end path forming section 55 relatively pivot so as to be bent. Then, as shown in FIG. 15, the contact rod 101 contacts against the base end path forming section 54.

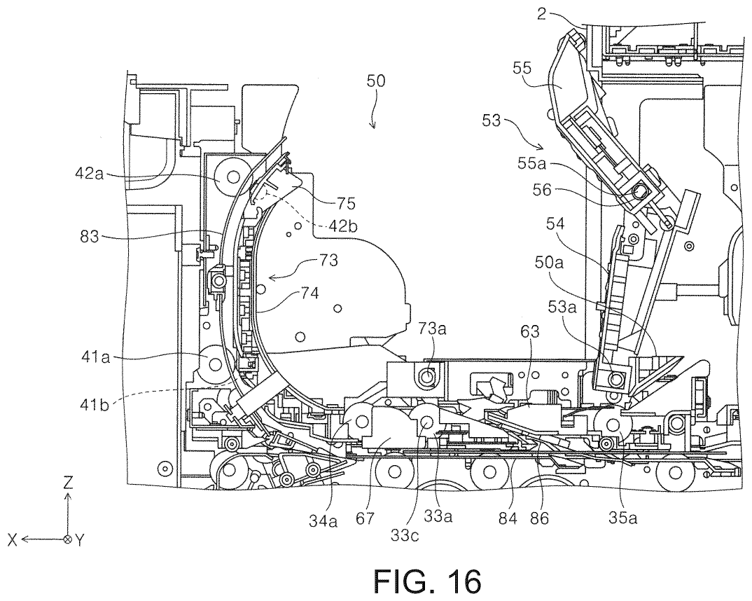

When the pull-out unit 50 is further displaced in the accommodation direction in a state in which the contact rod 101 is in contact with the base end path forming section 54 as described above, the base end path forming section 54 is pushed in the +X direction by the contact rod 101 and pivots in the closing direction, as shown by the change from FIG. 15 to FIG. 16. At this time, since the free end path forming section 55 is maintained in a state of being in contact with the housing 2 by the spring force of the torsion spring 56, the base end path forming section 54 and the free end path forming section 55 relatively pivot in a direction of the forming a linear shape.

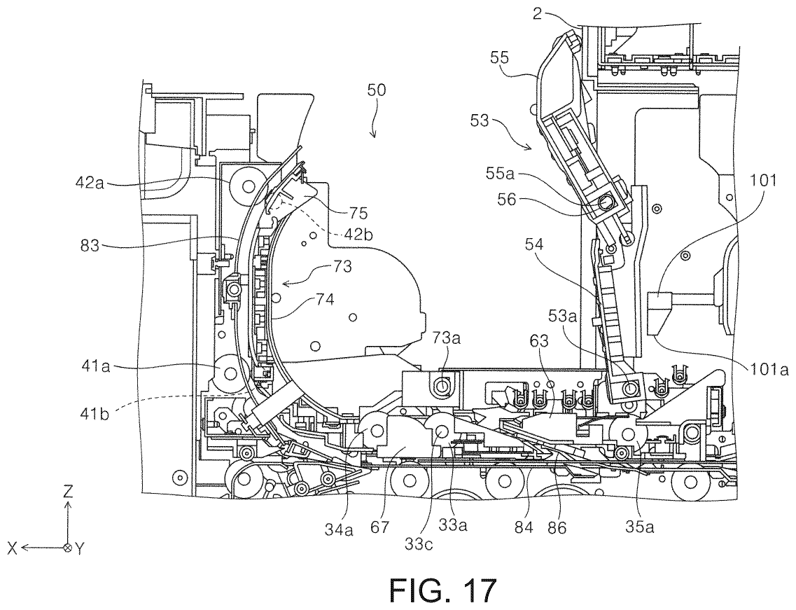

Furthermore, when the pull-out unit 50 is displaced in the accommodation direction, as shown by the change from FIG. 16 to FIG. 17, the base end path forming section 54 further pivots in the closing direction, and the base end path forming section 54 and the free end path forming section 55 pivot relatively further, resulting in the base end path forming section 54 and the free end path forming section 55 become even more linear shape. At this time, a section of the contact rod 101 contacting the base end path forming section 54 changes to the extension section 101a. Since the extension section 101a is provided in this manner, the position where the contact rod 101 contacts the base end path forming section 54 approaches the pivot shaft 53a, making it easier for the base end path forming section 54 to pivot in the closing direction when the pull-out unit 50 is displaced in the accommodation direction.

When the base end path forming section 54 is pivoted in the closing direction by the contact rod 101, as is clear from FIG. 17, the first path forming section 53 assumes a posture pivoted in the closing direction rather than a posture standing vertically as a whole, and the position of the center of gravity of the first path forming section 53 (not shown) is positioned in the closing direction or +X direction rather than the axis center of the pivot shaft 53a. By this, the first path forming section 53 tends to pivot in the closing direction due to its own weight.

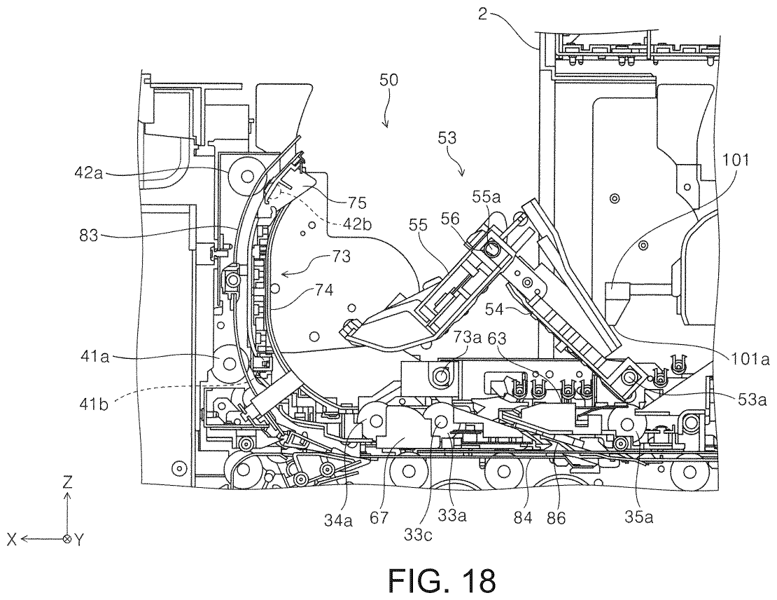

Further, when the pull-out unit 50 is displaced in the accommodation direction, although not shown, the base end path forming section 54 and the free end path forming section 55 temporarily become linear shape. However, as the entire the first path forming section 53 pivots in the closing direction, its own weight of the free end path forming section 55 overcomes the spring force of the torsion spring 56. By this, as shown by the change from FIG. 17 to FIG. 18, the free end path forming section 55 pivots in the counterclockwise direction, that is, the closing direction of the figure, against the spring force of the torsion spring 56, causing the base end path forming section 54 and the free end path forming section 55 to relatively pivot so as to bend. By this, the free end path forming section 55 contacts and is supported by the fourth path forming section 73 in the closed state.

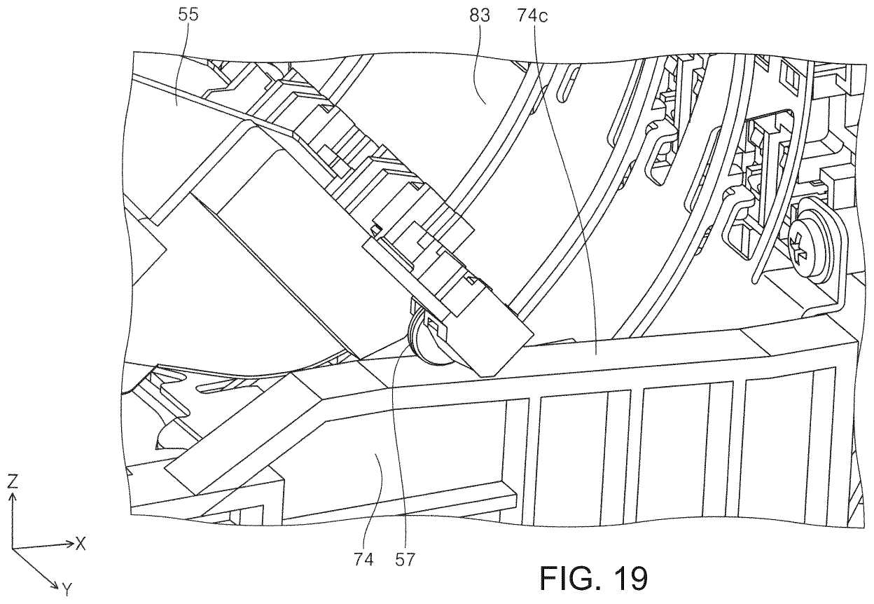

More specifically, as shown in FIG. 19, a driven roller 57 is provided on the free end side of the free end path forming section 55. A guide surface 74c is formed on the base section 74 constituting the fourth path forming section 73. The driven roller 57 and the guide surface 74c are positioned at a position deviated from the medium transport region in the Y-axis direction, and specifically, are provided at an end section in the +Y direction.

When the free end path forming section 55 pivots in the closing direction against the spring force of the torsion spring 56, the driven roller 57 contacts against the guide surface 74c, and the free end path forming section 55 is supported by the fourth path forming section 73 in the closed state.

When the pull-out unit 50 is further displaced in the accommodation direction from this state, the base end path forming section 54 is further pivoted in the closing direction by its own weight and an external force received from the extension section 101a of the contact rod 101. At this time, the free end path forming section 55 pivots relative to the base end path forming section 54 as shown by the change from FIG. 18 to FIG. 20 with the rotation of the driven roller 57 while being supported by the guide surface 74c via the driven roller 57, and the base end path forming section 54 and the free end path forming section 55 become further linear shape.

Since the fourth path forming section 73 takes the fourth closed state has the guide surface 74c for guiding the free end path forming section 55 when the first path forming section 53 changes its posture from the first open state to the first closed state, the first path forming section 53 can smoothly change its posture toward the first closed state. Note that the free end path forming section 55 may be configured to slide in contact with the guide surface 74c without including the driven roller 57.

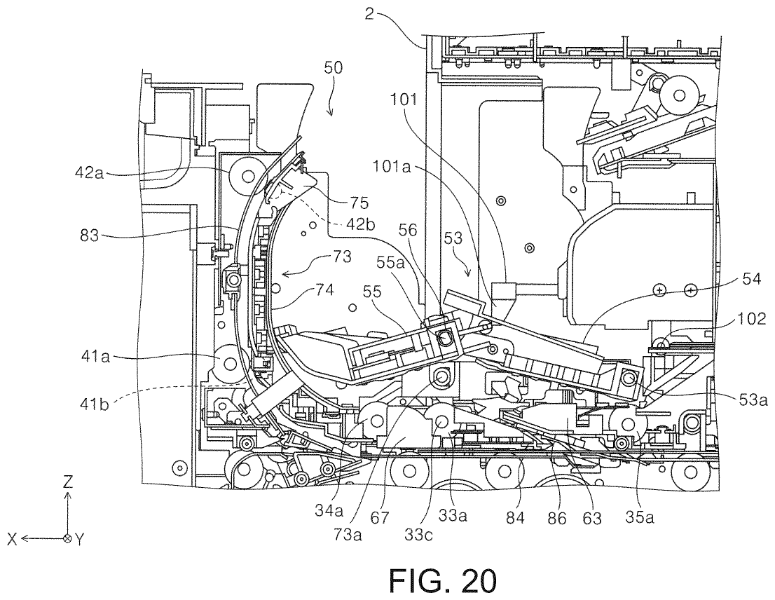

When the pull-out unit 50 is further displaced in the accommodation direction from the state shown in FIG. 20, the extension section 101a of the contact rod 101 is separated from the base end path forming section 54, but the first path forming section 53 is basically closed by its own weight. However, the housing 2 is provided with a contact plate 102 as a unit for keeping the first path forming section 53 in a completely closed state.

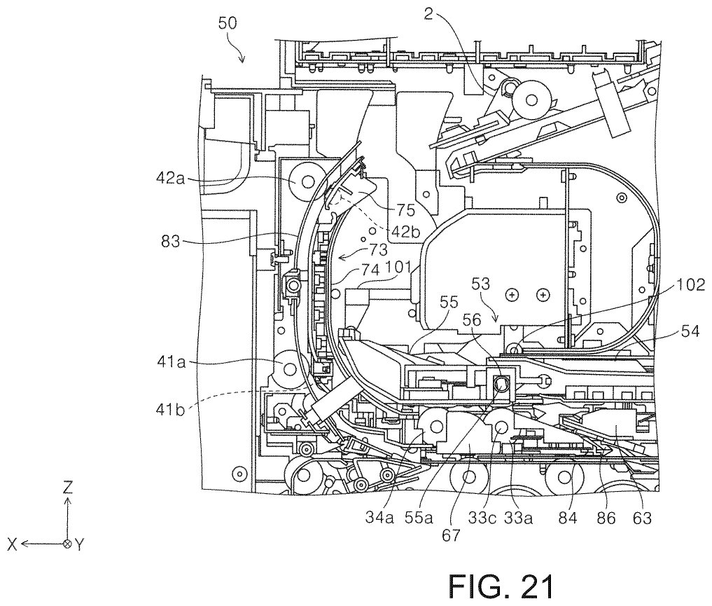

The contact plate 102 functions to press the first path forming section 53 from the upper side to the lower side when the pull-out unit 50 is displaced in the accommodation direction, as shown by the change from FIG. 20 to FIG. 21. By this, as shown by the change from FIG. 21 to FIG. 22, the first path forming section 53 is reliably brought into the completely closed state, that is, the first closed state.

Note that the contact plate 102 is an example of the first contact section that can is in contact with the base end path forming section 54 in the opened state in accordance with the displacement of the pull-out unit 50 in the accommodation direction. Note that here, the base end path forming section 54 in the opened state means the base end path forming section 54 in a case where the first path forming section 53 is in a state of being opened even slightly from the first closed state.

As described above, with the contact rod 101 or the contact plate 102, which is an example of the first contact section, contacts against the base end path forming section 54 in the open state, the pull-out unit 50 is displaced in the accommodation direction, causing the first path forming section 53 to change position toward the first closed state. By this, breakage of the first path forming section 53 can be suppressed when the pull-out unit 50 is to be accommodated while the first path forming section 53 is in the open state.

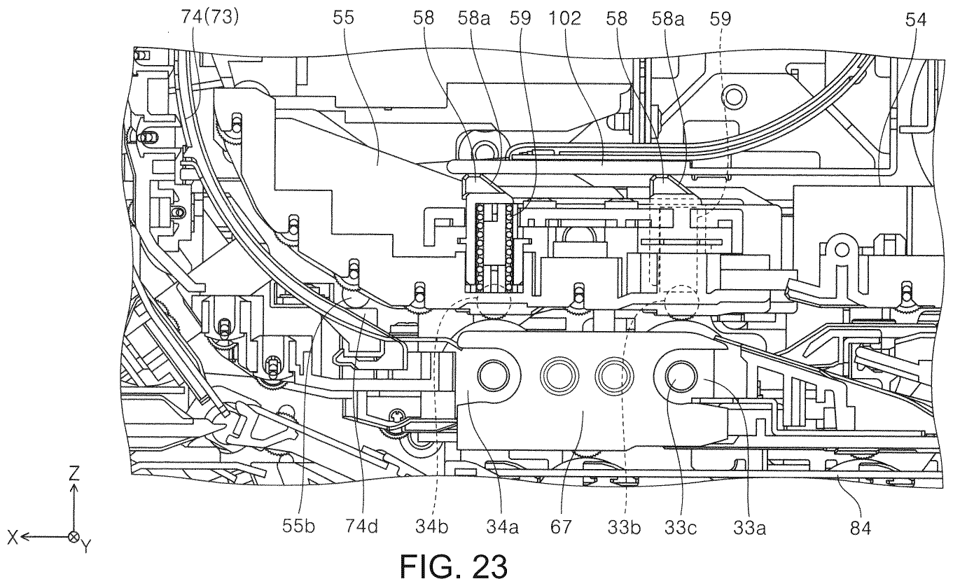

Note that in the first closed state, the first path forming section 53 is pressed so as to maintain the first closed state. Specifically, as shown in FIG. 23, the first path forming section 53 is provided with a pressing section 58. In the present embodiment, the pressing sections 58 are provided at intervals in the X-axis direction. The pressing section 58 is pressed in the +Z direction by a compression coil spring 59, which is an example of a pressing member. Note that the movement limit of the pressing section 58 in the +Z direction is restricted by a contact section (not shown). In the first closed state of the first path forming section 53, the first path forming section 53 is pressed in the −Z direction, that is, is pressed toward the first closed state by contacting the contact plate 102 and the pressing section 58. By this, the first closed state of the first path forming section 53 can be appropriately maintained.

Note that in the −X direction, that is, in the accommodation direction of the pull-out unit 50 at the upper portion of the pressing section 58, a guide surface 58a is formed, so that the pressing section 58 is prevented from being caught when it enters the lower side of the contact plate 102.

Here, the first path forming section 53 includes the driven roller 33b constituting the transport roller pair 33 and the driven roller 34b constituting the transport roller pair 34. The driven rollers 33b and 34b are pressed toward the opposing drive rollers 33a and 34a by a pressing member (not shown), for example, a spring. Therefore, in the first closed state, the first path forming section 53 receives reaction forces in the +Z direction from the drive rollers 33a and 34a via the driven rollers 33b and 34b. The reaction force is in a direction in which the first path forming section 53 releases the first closed state, but as described above, in the first closed state of the first path forming section 53, the first path forming section 53 is pressed in the −Z direction by the contact between the contact plate 102 and the pressing section 58, and thus the first path forming section 53 can appropriately maintain the first closed state. In addition, the nip pressure in the transport roller pairs 33 and 34 can be appropriately maintained.

In addition, since the third path forming section 67 includes the drive rollers 33a and 34a, the third path forming section 67 receives forces in the closing direction from the driven rollers 33b and 34b, that is, the first path forming section 53 via the drive rollers 33a and 34a. By this, the third path forming section 67 can appropriately maintain the closed state, that is, the third closed state.

Note that in FIG. 23, reference symbol 55b denotes a contact section where the first path forming section 53 contacts the fourth path forming section 73, and reference symbol 74d denotes a contacted section where the contact section 55b contacts in the fourth path forming section 73.

Note that although FIG. 15 to FIG. 22 show a process in which the first path forming section 53 closes in a state where the second path forming section 63 is closed, since the second path forming section 63 pivots coaxially with the first path forming section 53, even when the first path forming section 53 closes from a state where the second path forming section 63 is open together with the first path forming section 53 as shown in FIG. 9, the second path forming section 63 can be closed by in contact with the second path forming section 63 during the process in which the first path forming section 53 closes.

At this time, even when the third path forming section 67 is in an open state, the third path forming section 67 and the second path forming section 63 are configured not to interfere with each other, therefore the second path forming section 63 can be closed.

When the pull-out unit 50 is displaced in the accommodation direction, even when the third path forming section 67 is in the third open state as shown in FIG. 10 in addition to the first path forming section 53, as described below, the first path forming section 53 can pivot the third path forming section 67 in the closing direction, and the third path forming section 67 can be closed while suppressing damage to the third path forming section 67.

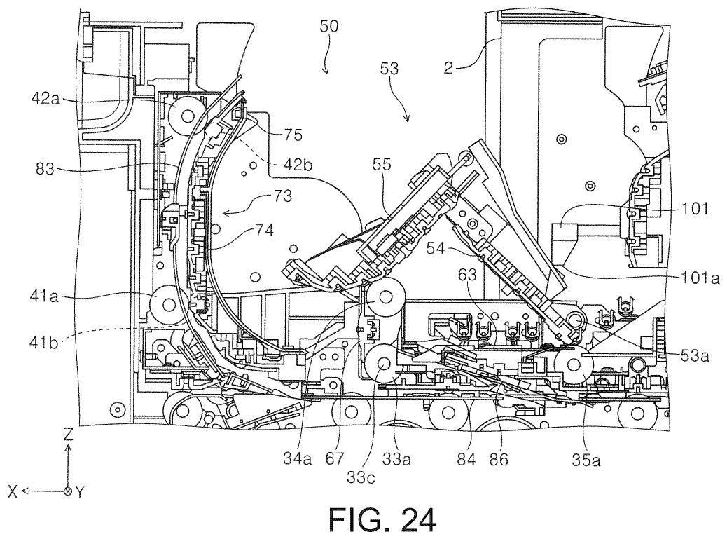

FIG. 24 shows a process in which the first path forming section 53 is closed while the third path forming section 67 is in the third open state. When the first path forming section 53 is closed while the third path forming section 67 is in the third open state, the free end path forming section 55 is in contact with the third path forming section 67 as shown in FIG. 24. Note that in the present embodiment, the timing at which the free end path forming section 55 contacts the third path forming section 67 is before the timing at which the free end path forming section 55 contacts the fourth path forming section 73, but it may be after the timing at which the free end path forming section 55 contacts the fourth path forming section 73.

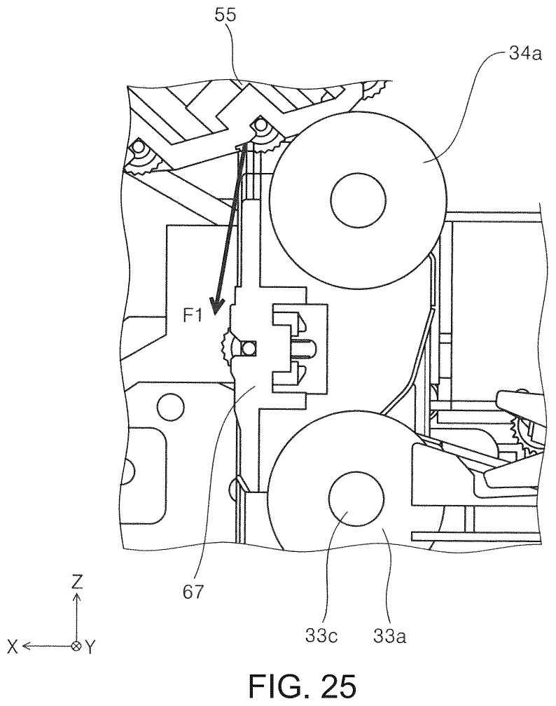

FIG. 25 is an enlarged view of the third path forming section 67 of FIG. 24, and reference symbol F1 indicates an external force applied to the third path forming section 67 by the free end path forming section 55. Since the external force F1 includes a +X-direction component, when the free end path forming section 55 contacts the third path forming section 67, the free end path forming section 55 applies an external force in the direction of closing the third path forming section 67. This is because the third path forming section 67 and the first path forming section 53 open in the same direction, in other words, close in the same direction. By this, the third path forming section 67 pivots in the closing direction, the engagement section 67a provided in the third path forming section 67 (see FIG. 11) disengages from the engaged section 74a provided in the fourth path forming section 73 (see FIG. 11), and it can be in the third closed state. Note that the first path forming section 53 may be in contact with the main body of the third path forming section 67 or may be in contact with the drive roller 34a.

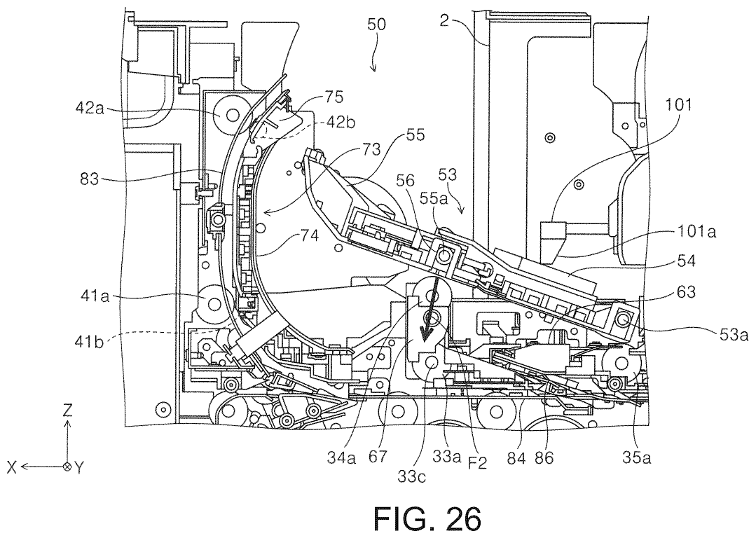

Note that in a case where the free end path forming section 55 contacts against the third path forming section 67 and the third path forming section 67 maintains the third open state, the first path forming section 53 may become linear shape while the free end path forming section 55 is in contact with the third path forming section 67 as shown in FIG. 26. Even in this case, as indicated by arrow F2 in FIG. 26, since the external force applied by the free end path forming section 55 to the third path forming section 67 includes a +X direction component, the third path forming section 67 can be closed as the first path forming section 53 is closed by being pushed by the extension section 101a of the contact rod 101.

At this time, even when the second path forming section 63 is in an open state, the second path forming section 63 and the third path forming section 67 are configured not to interfere with each other as described above, therefore, in addition to the second path forming section 63, the third path forming section 67 can also be closed.

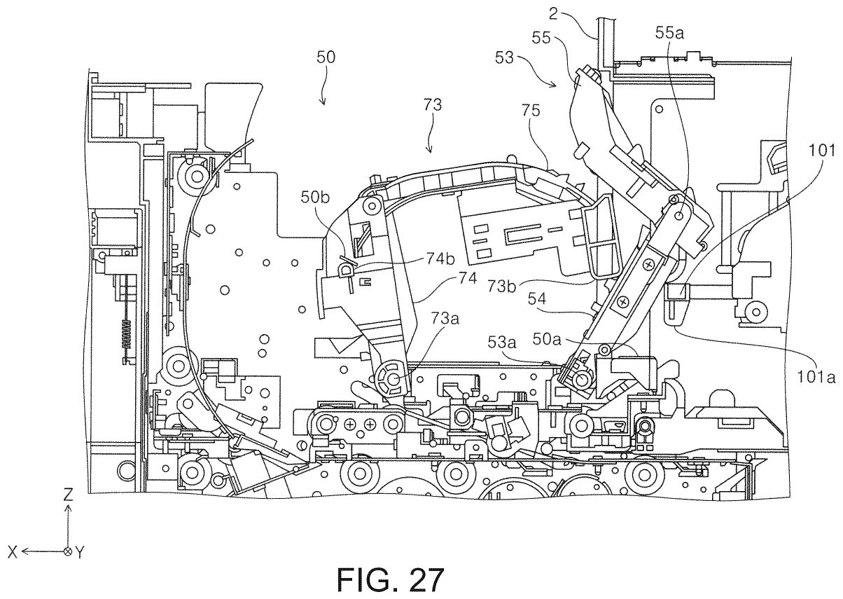

Next, FIG. 27 shown a state where the fourth path forming section 73 is in the fourth open state in addition to the first path forming section 53 when the pull-out unit 50 is displaced in the accommodation direction. Even in this case, as will be described below, the first path forming section 53 can pivot the fourth path forming section 73 in the closing direction, and the fourth path forming section 73 can be closed while suppressing damage to the fourth path forming section 73.

When the pull-out unit 50 is displaced in the accommodation direction, as described above, the base end path forming section 54 constituting the first path forming section 53 is pushed by the contact rod 101 and pivots in the closing direction. As a result, the base end path forming section 54 applies an external force in a closing direction to the fourth path forming section 73 via the handle section 73b of the fourth path forming section 73, and the fourth path forming section 73 pivots in a closing direction. This is because the fourth path forming section 73 and the first path forming section 53 open in the same direction, in other words, close in the same direction. When the fourth path forming section 73 pivots in the closing direction to some extent, the position of the center of gravity (not shown) of the fourth path forming section 73 moves from the axis center of the pivot shaft 73a to the closing side, that is, in the +X direction, and the fourth path forming section 73 can pivot in the closing direction by its own weight to be closed.

In this manner, it is possible to suppress damage to the fourth path forming section 73 due to the first path forming section 53 is in contact with the fourth path forming section 73.

Although not shown, even when the fourth path forming section 73 is in the fourth open state and the second path forming section 63 is in the second open state as shown in FIG. 13, the fourth path forming section 73 can be closed in the same manner as described with reference to FIG. 27.

That is, the fourth path forming section 73 and the second path forming section 63 open in the same direction, in other words, close in the same direction. Therefore, when the second path forming section 63 is closed together with the first path forming section 53, the second path forming section 63 applies an external force in the closing direction to the fourth path forming section 73 via the handle section 73b of the fourth path forming section 73, and the fourth path forming section 73 can pivot in the closing direction. By this, even if the pull-out unit 50 is displaced in the accommodation direction when the first path forming section 53 is in the first open state, the second path forming section 63 is in the second open state, and the fourth path forming section 73 is in the fourth open state, it is possible to suppress damage to the path forming sections.

Next, other characteristic configurations of the pull-out unit 50 will be described.

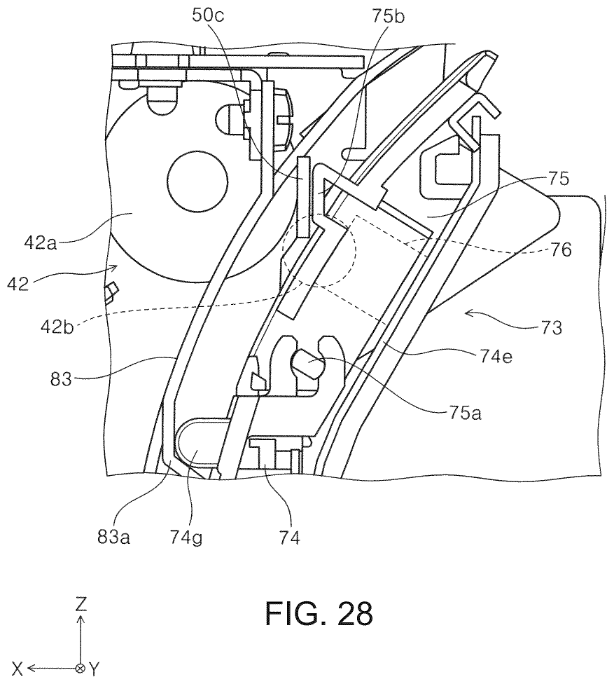

FIG. 28 shows the free end of the fourth path forming section 73. A part of the fourth transport path R4 (see FIG. 2) is formed between the fourth path forming section 73 and a fifth path forming section 83, which is facing to the fourth path forming section 73.

The fourth path forming section 73 has the base section 74 pivotable to switch between the fourth open state and the fourth closed state, and a pivot section 75 that is a section facing the fifth path forming section 83 downstream of the fourth transport path R4 from the base section 74 and that is pivotably coupled with respect to the base section 74. The pivot section 75 pivots around a pivot shaft 75a. The pivot shaft 75a has an axis center parallel to the Y-axis direction.

The fourth path forming section 73 has a compression coil spring 76 as the pivot section pressing unit for pressing the pivot section 75 toward the fifth path forming section 83. Reference symbol 74e denotes a base frame constituting the base of the base section 74 and the compression coil spring 76 exerts a spring force between the pivot section 75 and the base frame 74e.

The transport roller pair 42 is disposed in a region formed by the pivot section 75 and the fifth path forming section 83 in the fourth transport path R4.

A driven roller 42b is pressed toward a drive roller 42a by the compression coil spring 76. Note that reference symbol 50c is a contacted section provided in the pull-out unit 50, and reference symbol 75b is a contact section provided in the pivot section 75. The contact section 75b is pressed against the contacted section 50c by the spring force of the compression coil spring 76, thereby a gap of the path of the fourth transport path R4 is appropriately maintained.

According to the above described configuration, the following operational effects can be obtained.

When the transport roller pair 42 is provided in a region far from the pivot shaft 73a of the fourth path forming section 73, it is difficult to obtain the nip pressure of the transport roller pair 42.

However, as described above, the fourth path forming section 73 has the base section 74, the pivot section 75 pivotable with respect to the base section 74, and the compression coil spring 76 for pressing the pivot section 75 toward the fifth path forming section 83. Since the driven roller 42b is pressed toward the drive roller 42a by the compression coil spring 76, an appropriate nip pressure can be obtained.

To enable the transport of a small-sized medium, it is necessary to increase the number of transport roller pairs per predetermined distance in the transport direction. In the present embodiment, the fourth transport path R4 is provided with two transport roller pairs, that is, the transport roller pair 41 and the transport roller pair 42, as shown in FIG. 2, and each of the transport roller pairs is configured such that the driven roller is pressed against the drive roller. Therefore, in the fourth path forming section 73, due to the reaction force received from the drive roller, the nip force tends to be insufficient, particularly in the transport roller pair 42 on the free end side. However, as described above, the fourth path forming section 73 has the pivot section 75 that is pivotable with respect to the base section 74 and the compression coil spring 76 for pressing the pivot section 75 toward the fifth path forming section 83, and since the driven roller 42b that constitutes the transport roller pair 42 is provided in the pivot section 75, an appropriate nip pressure can be obtained in the transport roller pair 42.

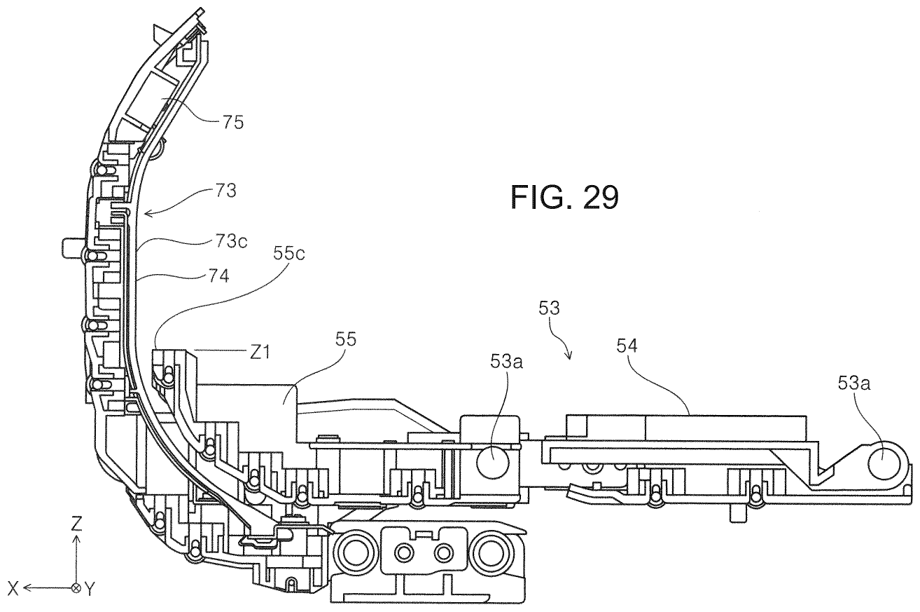

Next, FIG. 29 shows the positional relationship between the first path forming section 53 in the first closed state and the fourth path forming section 73 in the fourth closed state. The fourth path forming section 73 faces the first path forming section 53 in a region below a height position Z1 and does not face the first path forming section 53 in a region above the height position Z1. In such a configuration, the fourth path forming section 73 can be accessed without opening the first path forming section 53, and the user tries to open the fourth path forming section 73 without opening the first path forming section 53. As a result, a tip end section 55c of the first path forming section 53 is strongly pressed against the fourth path forming section 73, and the path forming surface of the fourth path forming section 73 may be damaged.

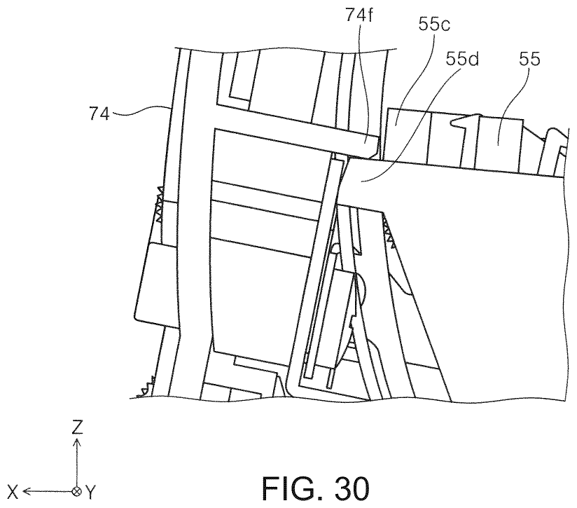

In order to suppress such a problem, as shown in FIG. 30, the first path forming section 53 according to the present embodiment has a restriction section 55d which restricted the opening of the fourth path forming section 73 in the first closed state or a state between the first closed state and the first open state.

When the fourth path forming section 73 is opened from the state shown in FIG. 29, the fourth path forming section 73 is in contact with the first path forming section 53 to slightly pivot the first path forming section 53 in the opening direction. When this state continues, as described above, the tip end section 55c of the first path forming section 53 damages the path forming surface of the fourth path forming section 73. However, since the restriction section 55d is in contact with a restricted section 74f of the fourth path forming section 73, the pivoting of the first path forming section 53 and the fourth path forming section 73 in the opening direction is restricted. By this, it is possible to suppress damage to the path forming surface of the fourth path forming section 73 due to the tip end section 55c of the first path forming section 53 being strongly pressed against the fourth path forming section 73.

Note that before the tip end section 55c of the first path forming section 53 contacts the path forming surface of the fourth path forming section 73, it is desirable for the restriction section 55d to contact the restricted section 74f, but not limited to this. Even in a case where the tip end section 55c of the first path forming section 53 is in contact with the path forming surface of the fourth path forming section 73, if the pivoting of the first path forming section 53 and the fourth path forming section 73 in the opening direction is restricted by the restriction section 55d is in contact with the restricted section 74f, damage to the path forming surface of the fourth path forming section 73 is suppressed.

Note that in the fourth closed state, the fourth path forming section 73 is restricted from pivoting in the closing direction by the fifth path forming section 83 and a frame (not shown).

Specifically, note that in FIG. 28, reference symbol 74g denotes a contact section provided on the base section 74. When the contact section 74g contacts against a contacted section 83a of the fifth path forming section 83, the interval between the base section 74 and the fifth path forming section 83 is restricted, and the gap of the path of the fourth transport path R4 is appropriately maintained. Although not shown, the base section 74 contacts against the frame that constitutes the pull-out unit 50 at a position even closer to the transport roller pair 34, thereby restricting the closed state and appropriately maintaining the gap of the path of the fourth transport path R4. The pivot section 75 provided at the free end of the fourth path forming section 73, the contact section 75b is pressed against the contacted section 50c as described with reference to FIG. 28, thereby the gap of the path of the fourth transport path R4 is appropriately maintained.

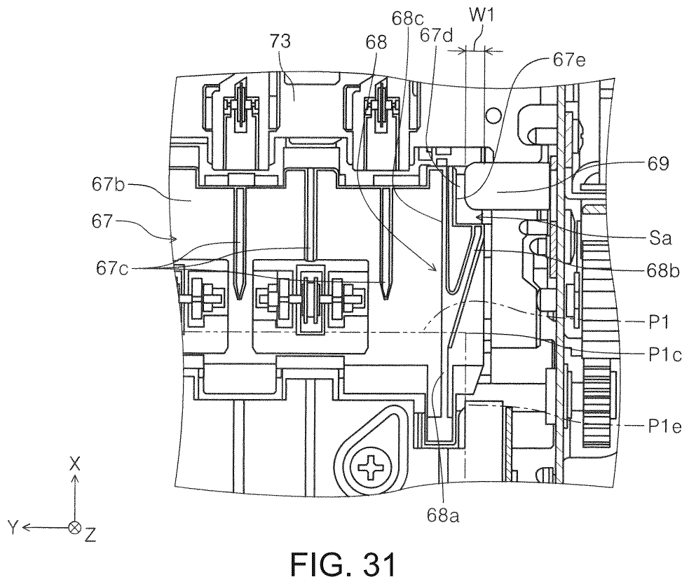

In the third closed state, the third path forming section 67 is restricted from pivoting in the closing direction by contact with a contact section 69 (see FIG. 31 to FIG. 33), and a gap of the path of the third transport path R3 is appropriately maintained.

In the second closed state, the second path forming section 63 is restricted from pivoting in the closing direction by contact with a frame (not shown), and a gap of the path of the second transport path R2 is appropriately maintained.

In the first closed state, as described with reference to FIG. 23, the contact section 55b of the first path forming section 53 contacts against the contacted section 74d of the fourth path forming section 73 in the fourth closed state and contacts against the second path forming section 63 in the second closed state, so that the pivoting in the closing direction is restricted and a gap of the path of the first transport path R1 is appropriately maintained.

Hereinafter, the third path forming section 67 will be further described with reference to FIG. 31 to FIG. 33.

In FIG. 31 to FIG. 33, the third path forming section 67 has a supported section 67d supported by the contact section 69. The contact section 69 is provided on both sides with respect to the third path forming section 67 in the Y-axis direction, that is, the width direction, and the contact section 69 and the supported section 67d provided in the −Y direction are shown in FIG. 31 to FIG. 33.

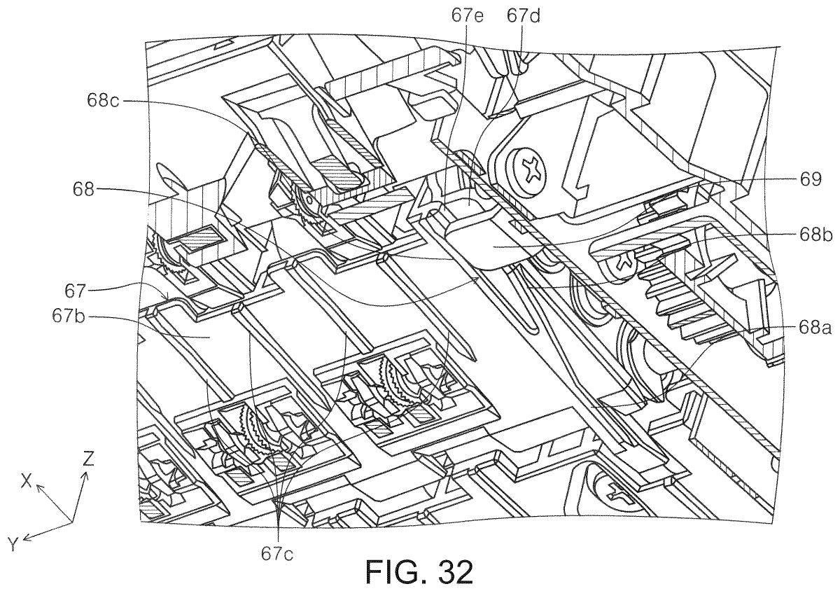

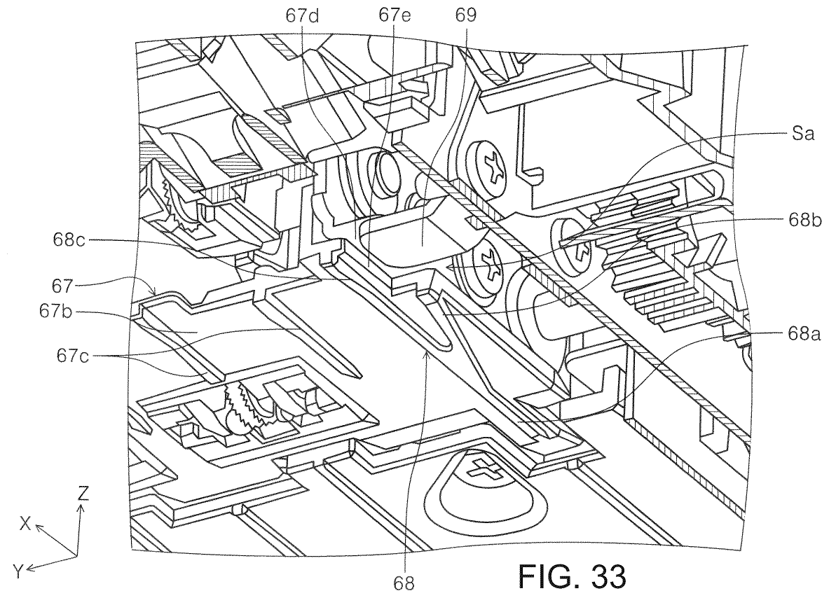

As shown by the change from FIG. 32 to FIG. 33, when the third path forming section 67 pivots toward the third closed state, the supported section 67d contacts against the contact section 69, the pivot of the third path forming section 67 is stopped, and the third closed state is formed.

The third path forming section 67 has a transport surface 67b forming the third transport path R3. Further, a notch section 67e into which the contact section 69 enters is formed at an end section in the widthwise direction in the third path forming section 67. By this, a gap Sa is formed between the downstream end of the transport surface 67b and the contact section 69 at the end portion in the width direction.

On the transport surface 67b, a plurality of ribs extending along the X-axis direction, that is, the transport direction, are provided at intervals along the Y-axis direction, that is, the width direction, which intersects with the transport direction. The plurality of ribs include linear ribs 67c extending in parallel along the transport direction and end section ribs 68 positioned at end sections in the width direction.

In FIG. 31, reference symbol P1 indicates a medium having the largest size in the width direction, a reference symbol P1e indicates a side edge of the medium P1 in the width direction, and a reference symbol P1c indicates a corner portion of the leading edge of the medium P1. When the medium P1 is transported downstream in the +X direction, that is, the transport direction, since the gap Sa is at a position where the side edge P1e passes, the corner portion P1c enters the gap Sa, and there is a possibility that a jam occurs in contact with the contact section 69. In order to suppress such a jam, it is necessary to provide a rib that separates the side edge P1e from the gap Sa, but when such a rib is provided at a position corresponding to the side edge P1e, there is also a possibility that the corner portion P1c may be caught by the rib, leading to a jam.

In order to suppress such a problem, the end section rib 68 positioned at the end section in the width direction among the plurality of ribs includes the following configuration.

The end section rib 68 has a first section 68a extending along the transport direction, and a second section 68b extending from a downstream end of the first section 68a in the transport direction to an outer side in the width direction toward downstream in the transport direction, that is, in the −Y direction so as to intersect with the transport direction. In other words, the second section 68b extends obliquely so as to form an acute angle with respect to the transport direction. At least a part of the second section 68b overlaps the contact section 69 in the width direction. In FIG. 31, reference symbol W1 indicates the range in which the second section 68b overlaps with the contact section 69.

According to such a configuration, the corner portion P1c of the leading edge of the medium P1 can be prevented from entering the gap Sa and is in contact with the contact section 69 by the second section 68b, thereby suppressing jamming. In addition, since the second section 68b extends the outer side in the widthwise direction along the transport direction so as to intersect with the transport direction, it is also possible to suppress the corner portion P1c from being caught by the second section 68b and to suppress jamming.

Note that even if the corner portion P1c enters the gap Sa, the jam can be suppressed as long as the corner portion P1c does not contact against the contact section 69, and therefore, it is also conceivable to further dispose the contact section 69 in the +Z direction. However, in this case, the third path forming section 67 may be increased in size in the Z-axis direction. In addition, in the present embodiment, since the third path forming section 67 supports the drive rollers 33a and 34a, it is difficult to further dispose the contact section 69 in the +Z direction. However, these problems can be suppressed by providing the second section 68b as described above.

Note that the end section rib 68 is positioned downstream of the first section 68a in the transport direction and has a third section 68c connected to the first section 68a. The third section 68c extends parallel to the transport direction in the same manner as the first section 68a. Since the third section 68c is provided, it is possible to suppress the leading edge of the medium from being caught by the fourth path forming section 73. However, the third section 68c may be formed to extend an inner side in the width direction, that is, in the +Y direction toward the downstream in the transport direction so as to intersect with the transport direction.

Although the gap Sa is formed between the third path forming section 67 and the contact section 69 in the present embodiment, the gap Sa may be formed between the third path forming section 67 and another section. The end section rib 68 having the second section 68b is not limited to being provided in the third path forming section 67 but may be provided in other path forming sections.

In this embodiment, the end section rib 68 having the second section 68b is provided at the end section in the −Y direction, but it may be provided at the end section in the +Y direction, or it may be provided at both the end section in the −Y direction and the end section in the +Y direction. In the case where the third path forming section 67 is provided at only one of the end section in the −Y direction and the end section in the +Y direction, it is desirable when the third path forming section 67 is not symmetrical with respect to the center position in the Y-axis direction, that is, the width direction.

The present disclosure is not limited to the embodiments and modifications described above, various modifications are possible within the scope of the disclosure described in the claims, it is needless to say that they are also included in the scope of the present disclosure.

What is claimed is:

1. A recording device comprising:
a housing;
a recording section that is accommodated in the housing and that is configured to perform recording on a medium;
a transport path configured to transport the medium that was recorded by the recording section in a transport direction; and
a pull-out unit configured to pull out at least a part of the transport path with respect to the housing, wherein
a part of the transport path is constituted by a first transport path,
the pull-out unit has an openable and closable first path forming section,
the first path forming section
in a first closed state, forms an upper surface of at least a part of the first transport path and
in a first open state, opens at least the part of the first transport path, and the first path forming section further has
a base end path forming section, which is a section on a base end side during opening and closing and
a free end path forming section, which is a section on a free end side during opening and closing, and which is pivotably coupled to the base end path forming section.

2. The recording device according to claim 1, wherein
when the first path forming section is opened from the first closed state toward the first open state, the free end path forming section and the base end path forming section pivot relative to each other after the free end path forming section contacts against a part of the housing, whereby the base end path forming section is further opened in an opening direction.

3. The recording device according to claim 2, wherein
the first path forming section further has a biasing member configured to bias the free end path forming section in the opening direction.

4. The recording device according to claim 1, wherein
the housing has a first contact section configured to contact the base end path forming section, which is in an open state, in response to displacement of the pull-out unit in an accommodation direction, which is a direction in which the pull-out unit is accommodated into the housing and
in a state where the first contact section is in contact with the base end path forming section in the opened state, the posture of the first path forming section is changed toward the first closed state by displacing the pull-out unit in the accommodation direction.

5. The recording device according to claim 4, wherein
the first path forming section has a pressing section and
in the first closed state of the first path forming section, the first path forming section is pressed toward the first closed state by contacting the first contact section and the pressing section.

6. The recording device according to claim 1, wherein
a part of the transport path is constituted by a second transport path,
the pull-out unit has an openable and closable second path forming section, and
the second path forming section
in a second closed state, forms a lower surface of at least a part of the first transport path and forms an upper surface of at least a part of the second transport path and
in a second open state, opens at least the part of the second transport path.

7. The recording device according to claim 6, wherein
the second path forming section pivots coaxially with the first path forming section.

8. The recording device according to claim 6, wherein
a part of the transport path is constituted by a third transport path,
the pull-out unit has an openable and closable third path forming section, and
the third path forming section
in a third closed state, forms the lower surface of at least a part of the first transport path and forms an upper surface of at least a part of the third transport path and
in a third open state, opens at least the part of the third transport path.

9. The recording device according to claim 8, wherein
the second path forming section and the third path forming section do not interfere with each other.

10. The recording device according to claim 8, wherein
the third path forming section is configured to open in the opening direction of the first path forming section and
when the first path forming section while transitioning from the first open state to the first closed state contacts the third path forming section in the third open state, the first path forming section applies an external force in a closing direction to the third path forming section.

11. The recording device according to claim 8, wherein
a part of the transport path is constituted by a fourth transport path,
the pull-out unit has an openable and closable fourth path forming section, and
the fourth path forming section
in a fourth closed state, forms the lower surface of at least a part of the first transport path and forms an upper surface of at least a part of the fourth transport path and
in a fourth open state, opens at least the part of the fourth transport path.

12. The recording device according to claim 11, wherein
the fourth path forming section has a region facing and a region not facing the first path forming section and
the first path forming section has a restriction section configured to restrict opening of the fourth path forming section while in the first closed state or in a state between the first closed state and the first open state.

13. The recording device according to claim 11, wherein
the fourth path forming section that takes the fourth closed state has a guide surface configured to, when the first path forming section changes its posture from the first open state to the first closed state, guide the free end path forming section.

14. The recording device according to claim 11, wherein
the fourth transport path is provided with a transport roller pair configured to nip and transport the medium,
at least a part of the fourth transport path is formed between the fourth path forming section and a fifth path forming section facing the fourth path forming section,
the fourth path forming section has
a base section pivotable for switching between the fourth open state and the fourth closed state,
a pivot section that is a section facing the fifth path forming section downstream of the fourth transport path from the base section and that is pivotably coupled with respect to the base section, and
a pivot section pressing unit configured to press the pivot section toward the fifth path forming section,
the transport roller pair is disposed in a region formed by the pivot section and the fifth path forming section in the fourth transport path, and
one roller of the transport roller pair is pressed toward the other roller by the pivot section pressing unit.

15. The recording device according to claim 11, wherein
the fourth transport path is positioned downstream of the third transport path in the transport direction and
the third path forming section has an engagement section configured to, in the third open state, engage with an engaged section of the fourth path forming section in the fourth closed state.

16. The recording device according to claim 15, wherein
when the fourth path forming section opens toward the fourth open state while the engagement section that is in an engaged state engages with the engaged section, the engagement section disengages engagement with the engaged section and the third path forming section changes its posture toward the third closed state.

17. The recording device according to claim 11, wherein
the fourth path forming section is configured to open in the opening direction of the first path forming section and
when the first path forming section while transitioning from the first open state to the first closed state contacts the fourth path forming section in the fourth open state, the first path forming section applies an external force in a closing direction to the fourth path forming section.

18. The recording device according to claim 11, wherein
the fourth path forming section is configured to open in the opening direction of the second path forming section and
when the second path forming section while transitioning from the second open state to the second closed state contacts the fourth path forming section in the fourth open state, the second path forming section applies an external force in a closing direction to the fourth path forming section.

19. The recording device according to claim 8, wherein
the transport path has a feeding path configured to transport the medium toward the recording section,
the first transport path includes
at least a part of a switchback path configured to switch back the medium in order to inverse a front and back of the medium recorded by the recording section and
at least a part of an inversion path configured to inverse the medium that was switched back in the switchback path and to re-transport it to the feeding path,
the second transport path guides the medium recorded by the recording section to the switchback path, and
the third transport path guides the medium recorded by the recording section in a discharge direction.

20. The recording device according to claim 8, further comprising:
a contact section against which the third path forming section in the third closed state contacts in the transport direction, wherein
a plurality of ribs are provided on a transport surface that forms the third transport path in the third path forming section along a width direction, which intersects with the transport direction,
a notch section into which the contact section enters is formed at an end section in the width direction in the third path forming section,
a gap is formed between the downstream end of the transport surface and the contact section in the transport direction,
a rib of the plurality of ribs that is positioned at the end section in the width direction has
a first section extending along the transport direction and
a second section extending from a downstream end of the first section in the transport direction to an outer side in the width direction toward downstream in the transport direction so as to intersect with the transport direction, and
at least a part of the second section overlaps the contact section in the width direction.
